(19) United States
(12) Patent Application Publication
(10) Pub. No.: US 2003/0045274 A1
(43) Pub. Date: Mar. 6, 2003

(54) Mobile communication terminal, sensor unit, musical tone generating system, musical tone generating apparatus, musical tone information providing method, and program

(76) Inventor: Yoshiki Nishitani, Shizuoka-ken (JP)

Correspondence Address: HARNESS, DICKEY & PIERCE, P.L.C., P.O. BOX 828, BLOOMFIELD HILLS, MI, 48303, US

(21) Appl. No.: 10/235,018

(22) Filed: Sep. 4, 2002

(30) Foreign Application Priority Data
Sep. 5, 2001 (JP) 2001-269549

(51) Int. Cl. H04B 7/00; H04M 3/42; H04M 3/00; H04M 1/00; H04B 1/38

(52) U.S. Cl. 455/414; 455/420; 455/66; 455/575; 455/567

(57) ABSTRACT

There is provided a mobile communication terminal with which a user can easily participate in generation of musical tones utilizing contents of a motion of the user. A mobile communication terminal receives communication services via a mobile communication network. A motion sensor detects a motion of a user on the mobile communication terminal. A storage device stores musical tone information. A control information generating device generates musical tone control information in accordance with results of detection of the motion sensor. A musical tone generating device generates musical tones based on the musical tone information stored in the storage device and the musical tone control information generated by the control information generating device.

### BACKGROUND OF THE INVENTION

1. Field of the Invention

The present invention relates to a mobile communication terminal for performing generation of musical tones or other processes over a mobile communication network, a sensor unit which is mounted on the terminal, a musical tone generating system, a musical tone generating apparatus, a musical tone information providing method, and a program for realizing the method.

2. Description of the Related Art

Audio systems and other musical tone generating apparatuses can generate desired musical tones once four performance parameters of tone color, pitch, volume, and effects are determined. MIDI (Musical Instrument Digital Interface) musical instruments and other musical tone generating apparatuses perform music based on music data. Users of the apparatuses adjust the volume and other performance parameters by control knobs, control buttons, etc. of the MIDI musical instruments.

As described above, in MIDI musical instruments and other musical tone generating apparatuses, the desired volume etc. are obtained by the user suitably operating control knobs or other operating elements. When a user listens to music performed by a musical tone generating apparatus at a desired volume etc., the method of adjustment of the performance parameters by control knobs is effective. In the conventional musical tone generating apparatuses, however, while it is possible to provide the user with faithful performance or reproduction of music based on music data, it is not possible to provide the user with the pleasure of actively participating in the performance of the music.

Therefore, a system may be considered in which motion sensors are attached to the body of the user, movement of the body of the user is detected by these sensors, the results of detection are radio transmitted to a musical tone generating apparatus is and music is played based on the detection results. By using such a system, it is possible to control the performance of music based on MIDI data etc. in accordance with motion of the user rather than having the user dance or otherwise move in accordance with the music and to thereby provide the user with a new form of participatory musical entertainment. However, the above-mentioned music performance requires a dedicated system which is comprised, for example, of a radio unit on which the motion sensors are mounted, and a musical tone generating apparatus to which the detection results are to be radio transmitted from the radio unit, which would be a drawback to easy-to-participate music performance. Further, partly because such a dedicated system cannot be easily carried about, the environment where the user can use the system is limited to his or her room at home or office, etc.

In addition to the above-mentioned requirement for controlling of generation of musical tones, when there is a demand for reflecting the contents of motion of the user in something, checking/recording the contents of motion of the user, or the like, it is essential to prepare dedicated equipment, which cannot be easily carried about out of home or office; for that reason, the user could not easily have the contents of his or her motion reflected in something and check or record the same while he or she is in a place remote from home or office.

### SUMMARY OF THE INVENTION

It is an object to provide a mobile communication terminal with which a user can easily participate in generation of musical tones utilizing contents of a motion of the user, a sensor unit to be mounted on the mobile communication terminal, a musical tone generating system, a musical tone generating apparatus, a musical tone information providing method, and a program for realizing the method.

To attain the above object, in a first aspect of the present invention, there is provided a mobile communication terminal for receiving communication services via a mobile communication network, comprising a motion sensor that detects a motion of a user on the mobile communication terminal, a storage device that stores musical tone information, a control information generating device that generates musical tone control information in accordance with results of detection of the motion sensor, and a musical tone generating device that generates musical tones based on the musical tone information stored in the storage device and the musical tone control information generated by the control information generating device.

In a preferred form of the first aspect, the mobile communication terminal according to the first aspect further comprises a requesting device that requests a musical tone information providing apparatus connected to the mobile communication network to supply musical tone data to the mobile communication terminal via the mobile communication network, and a receiving device that receives the musical tone data supplied from the musical tone information providing equipment via the mobile communication network, and wherein the storage device stores the musical tone data received by the receiving device.

To attain the above object, in a second aspect of the present invention, there is provided a mobile communication terminal for receiving communication services via a mobile communication network, comprising a motion sensor that detects a motion of a user on the mobile communication terminal, and a detection result transmitting device that transmits detection result information corresponding to results of detection of the motion sensor to an external device connected to the mobile communication network, via the mobile communication network.

To attain the above object, in a third aspect of the present invention, there is provided a mobile communication terminal for receiving communication services via a mobile communication network, comprising a microphone via which voice is input, a storage device that stores musical tone information, a control information generating device that generates musical tone control information based on the voice input via the microphone, and a musical tone generating device that generates musical tones based on the musical tone information stored in the storage device and the musical control information generated by the control information generating device.

To attain the above object, in a fourth aspect of the present invention, there is provided a sensor unit detachably mounted on a mobile communication terminal for receiving communication services via a mobile communication network, the mobile communication terminal including a storage device that stores musical tone information, and a musical tone generating device that generates musical tones in accordance with the musical tone information stored in the storage device and a motion of a user on the mobile communication terminal, the sensor unit comprising a motion sensor that detects the motion of the user on the mobile communication terminal with the sensor unit attached thereto and generates detection result information corresponding to results of detection of the motion sensor, and an output device that outputs the detection result information generated by the motion sensor, to the mobile communication terminal with the sensor unit mounted thereon.

To attain the above object, in a fifth aspect of the present invention, there is provided a sensor unit detachably mounted on a mobile communication terminal for receiving communication services via a mobile communication network, the mobile communication terminal including a storage device that stores musical tone information, the sensor unit comprising a motion sensor that detects a motion of a user on the mobile communication terminal with the sensor unit attached thereto, a control information generating device that generates musical tone control information based on results of detection of the motion sensor, and a musical tone generating device that reads the musical tone information stored in the storage device of the mobile communication terminal with the motion sensor attached thereto, and generates musical tones based on the musical tone information read from the storage device and the musical tone control information generated by the control information generating device.

To attain the above object, in a sixth aspect of the present invention, there is provided a musical tone generating system comprising a mobile communication terminal for receiving communication services via a mobile communication network, and a musical tone information generating device connected to the mobile communication network, the mobile communication terminal including at least one motion sensor built in the mobile communication terminal or attached to the mobile communication terminal, for detecting a motion of a user on the mobile communication terminal, and a detection result transmitting device that transmits detection result information corresponding to results of detection of the motion sensor to the musical tone information generating device via the mobile communication network, the musical tone information generating device including a receiving device that receives the detection result information transmitted from the mobile communication terminal, and a musical tone information generating section that generates musical tone information based on the detection result information received by the receiving device.

In a preferred form of the sixth aspect, the musical tone information generating device further includes a musical tone information transmitting device that transmits the musical tone information generated by the musical tone information generating section, to the mobile communication terminal via the mobile communication network, and wherein the mobile communication terminal further includes a musical tone generating device that generates musical tones based on the musical tone information transmitted from the musical tone information transmitting device of the musical tone information generating device based on the detection result information transmitted from the detection-result transmitting device.

Preferably, the musical tone information generating device further includes a musical tone generating device that generates musical tones based on the musical tone information generated by the musical tone information generating section.

In another preferred form of the sixth aspect, the musical tone information generating device further includes a musical tone information obtaining device obtaining second musical tone information from an external device, and an instruction transmitting device that, when generating the musical tone information based on the obtained second musical tone information obtained by the musical tone information obtaining device, transmits instruction information based on the obtained musical tone information to the mobile communication terminal via the mobile communication network, wherein the musical tone information generating section generates the musical tone information based on both the obtained second musical tone information and the detection result information, and wherein the mobile communication terminal further includes an instruction receiving device that receives the instruction information transmitted from the instruction transmitting device, and a notifying device that notifies the user of contents of an instruction corresponding to the instruction information received by the instruction receiving device.

To attain the above object, in a seventh aspect of the present invention, there is provided a musical tone generating apparatus comprising a receiving device that receives detection result information corresponding to results of detection of at least one motion sensor from a mobile communication terminal receiving communication services via a mobile communication network, the motion sensor detecting a motion of a user on the mobile communication network, and a musical tone information generating device that generates musical tone information based on the detection result information received by the receiving device.

Preferably, the musical tone generating apparatus according the seventh aspect further comprises a music information storage device that stores music information, and wherein the musical tone information generating device generates the musical tone information based on the music information stored in the music information storage device and the detection result information received by the receiving device.

Preferably, the receiving device receives the detection result information addressed to a plurality of predetermined access numbers, and wherein the music information comprises a plurality of parts allocated to respective ones of the access numbers and the musical tone information is to be generated for each of the parts, and the musical tone information generating device generates the musical tone information based on the music information for each of the parts and the detection result information addressed to a corresponding one of the access numbers.

Also preferably, the musical tone generating apparatus according to the seventh aspect further comprises a musical tone information transmitting device that transmits the musical tone information generated by the musical tone information generating device, to the mobile communication terminal as a source of transmission of the detection result information, via the mobile communication network.

To attain the above object, in an eighth aspect of the present invention, there is provided a method of providing musical tone information to a mobile communication terminal for receiving communication services via a mobile communication network, the mobile communication terminal having a motion sensor that detects a motion of a user on the mobile communication terminal, the method comprising the steps of causing a musical tone information providing apparatus connected to the mobile communication terminal to receive detection result information corresponding to results of detection of the motion sensor transmitted from the mobile communication terminal via the mobile communication network, generating musical tone information based on the received detection result information, and causing the musical tone information providing apparatus to transmit the generated musical tone information to the mobile communication terminal as a source of transmission of the detection result information, via the mobile communication network.

To attain the above object, in an eighth aspect of the present invention, there is provided a program for implementing a method of providing musical tone information to a mobile communication terminal for receiving communication services via a mobile communication network, the mobile communication terminal having a motion sensor that detects a motion of a user on the mobile communication terminal, the method comprising the steps of causing a musical tone information providing apparatus connected to the mobile communication terminal to receive detection result information corresponding to results of detection of the motion sensor transmitted from the mobile communication terminal via the mobile communication network, generating musical tone information based on the received detection result information, and causing the musical tone information providing apparatus to transmit the generated musical tone information to the mobile communication terminal as a source of transmission of the detection result information, via the mobile communication network.

According to the present invention, a motion of a user, such as thrust upward or swing, on the mobile communication terminal, is detected by the motion sensor, and musical tones are generated based on musical tone control information generated according to results of the detection and musical tone information stored in the mobile communication terminal. As a result, by using the mobile communication terminal capable of utilizing mobile telephone services, the user can generate desired musical tones reflecting the motion of the user on the mobile communication terminal even at a place remote from his or her home or office without carrying dedicated equipment for musical tone generation.

The above and other objects, features and advantages of the invention will become more apparent from the following detailed description taken in conjunction with the accompanying drawings.

### BRIEF DESCRIPTION OF THE DRAWINGS

FIG. 1 is a block diagram of the construction of a cellular phone according to a first embodiment of the present invention;

FIG. 2 is a view useful in explaining a musical tone generating process to be carried out by the cellular phone of FIG. 1;

FIG. 3 is a block diagram of the schematic construction of a network system in which the cellular phone of FIG. 1 is used;

FIG. 4 is a block diagram of the schematic construction of a network system in which a cellular phone according to a second embodiment of the present invention is used;

FIG. 5 is a block diagram of the construction of the cellular phone of FIG. 4 according to the second embodiment;

FIG. 6 is a view useful in explaining the manner in which control information for generation of a musical tone is transmitted by the cellular phone of FIG. 4 according to the second embodiment;

FIG. 7 is a block diagram of the construction of a musical tone generating apparatus for generating musical tones based on control information transmitted from the cellular phone of FIG. 4 according to the second embodiment;

FIG. 8 is a sequence flow chart illustrating the processing operation of the cellular phone of FIG. 4 according to the second embodiment and the musical tone generating device of FIG. 7 during execution of a musical generating process;

FIG. 9 is a block diagram of the schematic construction of a musical tone generating system according to a third embodiment of the present invention;

FIG. 10 is a block diagram of the construction of a cellular phone as a part of the musical tone generating system of FIG. 9 according to the third embodiment;

FIG. 11 is a block diagram of the construction of a musical tone generating apparatus as a part of the musical tone generating system of FIG. 9 according to the third embodiment;

FIG. 12 is a block diagram of the schematic construction of a network system to which a musical tone data providing method according to a fourth embodiment of the present invention is applied;

FIG. 13 is a block diagram of the construction of a cellular phone as a part of the network system of the fourth embodiment;

FIG. 14 is a block diagram of the schematic construction of a network system that performs medical checking using a cellular phone according to a variation of the present invention;

FIG. 15 is a view useful in explaining a musical tone generating process according to a cellular phone of another variation of the present invention;

FIG. 16 is a perspective view of the appearance of both a cellular phone according to a further variation of the present invention and a sensor unit to be mounted on the cellular phone; and

FIG. 17 is a block diagram of the construction of the cellular phone of FIG. 16 with the sensor unit of FIG. 16 mounted thereon.

### DETAILED DESCRIPTION OF THE PREFERRED EMBODIMENTS

Preferred embodiments of the present invention will now be described with reference to the accompanying drawings.

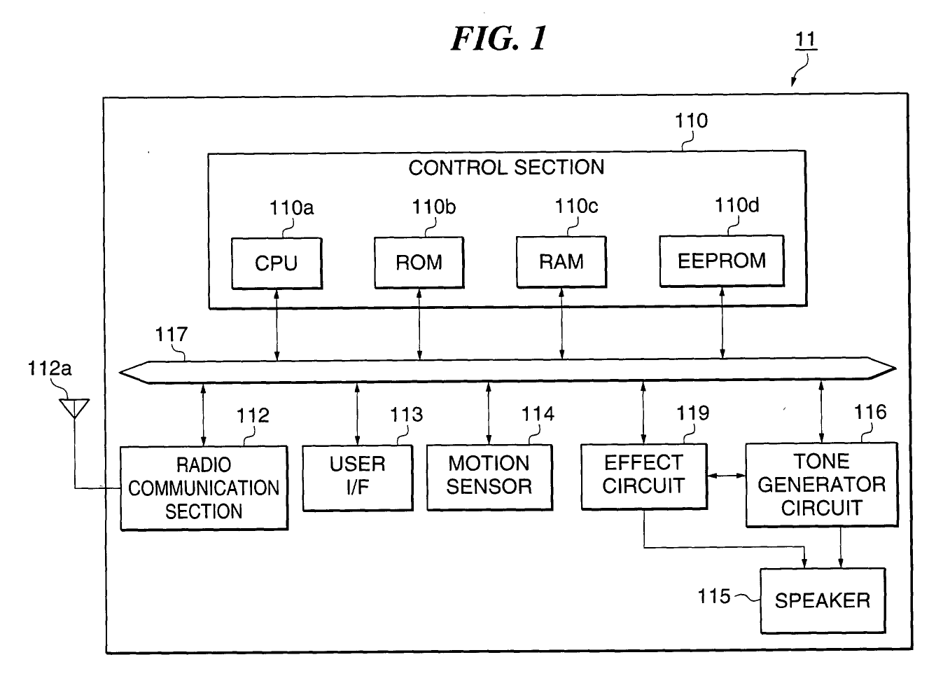

FIG. 1 is a block diagram of the construction of a cellular phone (mobile communication terminal) according to a first embodiment of the present invention. As shown in the figure, the cellular phone 11 is comprised of a control section 110, a radio communication section 112, a user interface section (I/F) 113, a motion sensor 114, a tone generator circuit 116, an effect circuit 119, a bus 117 connecting these parts to one another, and a sound speaker 115 connected to the tone generator circuit 116.

The control section 110 is comprised of a CPU (Central Processing Unit) 110a, a ROM (Read Only Memory) 110b, a RAM (Random Access Memory) 110c, and an EEPROM (Electrical Erasable Read Only Memory) 110d, and controls various parts of the cellular phone 11. In the ROM 110b, various control programs and data, such as an Id identifying the cellular phone 11 in a mobile communication service are stored. The CPU 110a realizes various functions, such as data communication and talking over telephone, by executing control programs stored in the ROM 110b and performs a control process for generation of musical tones, described later. The RAM 110c is used as a work area for the CPU 110a. In the EEPROM 110d, data such as telephone directory data as well as musical tone data downloaded to the cellular phone 11 via a mobile communication network, not shown, by a musical tone data providing service, described hereinafter, or other similar service. Musical tone data to be stored in the EEPROM 110d should by no means be limited to data for reproducing a certain piece of music (e.g., MIDI data) and may be musical tone data for generating wave sound, wind sound, percussion instrument sound, etc. In the present embodiment, the EEPROM is used as a storage device for storing musical tone data; but any type of rewritable storage device, such as a hard disk drive, may be used as an alternative.

The radio communication section 112 performs radio communication between the cellular phone 11 and a base station on a mobile communication network via an antenna 112a. The cellular phone 11 can thereby receive a radio communication service provided by the mobile communication network, enabling talking over telephone and data communications with a communication machine, such as another cellular phone or a fixed telephone via the mobile communication network.

The user interface section 113 is comprised of a liquid crystal display that displays various kinds of information, a keypad on which the user makes an input operation, a microphone through which the user takes over telephone, and a sound speaker. The radio communication section 112 and the user interface section 113 are similar in construction to radio communication sections and user interfaces of ordinary cellular phones, and detailed description of these sections is therefore omitted here.

The motion sensor 114 may be one of various known motion sensors, such as a three-dimensional acceleration sensor, a three-dimensional velocity sensor, a two-dimensional acceleration sensor, a two-dimensional velocity sensor, a strain detector or a tilt sensor, and detects a motion that the user has made by himself or herself on the cellular phone 11. Thus, the cellular phone 11 carries a motion sensor to be used in musical tone control described later, in addition to the interface section such as a keypad with which the user gives instructions to an ordinary cellular phone for telephone talking or data communication. If the motion sensor 114 is an acceleration sensor, it detects acceleration when the user moves the cellular phone 11 in the hand. Alternatively, the motion sensor 114, which is a strain sensor or a piezoelectric sensor, detects a striking motion when the user strikes a predetermined portion of the cellular phone 11 by the hand, for example. Accordingly, the motion sensor 114 detects a motion of the user on the cellular phone 11, performs predetermined signal processing (analog-to-digital conversion, filtering, etc.) on a signal indicating the result of detection, and outputs the resulting signal in terms of data of a format that can be processed by the control section 110.

In generating musical tones using the cellular phone 11, the control section 110 performs control processing for generating musical tones in accordance with a control program stored in the ROM 110b and generates control information for controlling the generation of musical tones, namely, the control information reflecting the motion of the user on the cellular phone 11 as detected by the motion sensor 114, using the data indicating the detection result output from the above-mentioned motion sensor 114. The details of the control information generating process will be described later.

The tone generator circuit 116 generates a musical tone signal based on the musical tone data stored in the EEPROM 110d of the control section 110. If the musical tone data stored in the EEPROM 110d is MIDI data for playing a certain piece of music, the tone generator circuit 116 is a MIDI tone generator and generates a musical tone signal according to the MIDI data. In thus generating a musical tone signal according to the musical tone data, the tone generator circuit 116 controls generation of the musical tone signal according to control information supplied from the control section 110. For example, if the supplied control information designates a volume and a tempo, the tone generator circuit 116 generates a musical tone signal such that a musical tone having a pitch and tone color corresponding to the MIDI data is produced with the volume and tempo designated by the control information. Thus, the tone generator circuit 116 generates a musical tone signal based on both the musical tone data stored in the EEPROM 110d and the control information supplied from the control section 110 and reflecting the motion of the user.

The effect circuit 119, which is composed of a digital signal processor (DSP), for example, applies desired effects such as reverberation, if necessary, to the musical tone signal generated by the tone generator circuit 116, and then outputs the resulting musical tone signal (or with no effect applied) to the sound speaker 115. When control information for application of effects is supplied from the control section 110, the effect circuit 119 applies one or more effects to the musical tone signal in accordance with the received control information. The sound speaker 115 sounds musical tones in accordance with the musical tone signal supplied from the effect circuit 119.

As described above, the cellular phone 11 is able to control musical tones to be produced from the sound speaker 115, by the control information reflecting the motion of the user. When the cellular phone 11 is set to a motion-reflecting performance mode in which musical tones thus reflecting the motion of the user are generated, the control section 110 executes a control information generating process for generating control information based on results of detection by the motion sensor 114, as described above. The manner of analyzing the results of detection by the motion sensor 114 and the form of the control information to be generated may be determined as desired, and these may be suitably determined depending on the type of the motion sensor 114 (a two-dimensional sensor, a three-dimensional sensor, a strain sensor, etc.) or the like. A description will now be given of an example of the control information generating process using a three-dimensional acceleration sensor as the motion sensor 114 and the operation of the cellular phone 11 in the motion-reflecting performance mode during the musical tone generating process including the control information generating process.

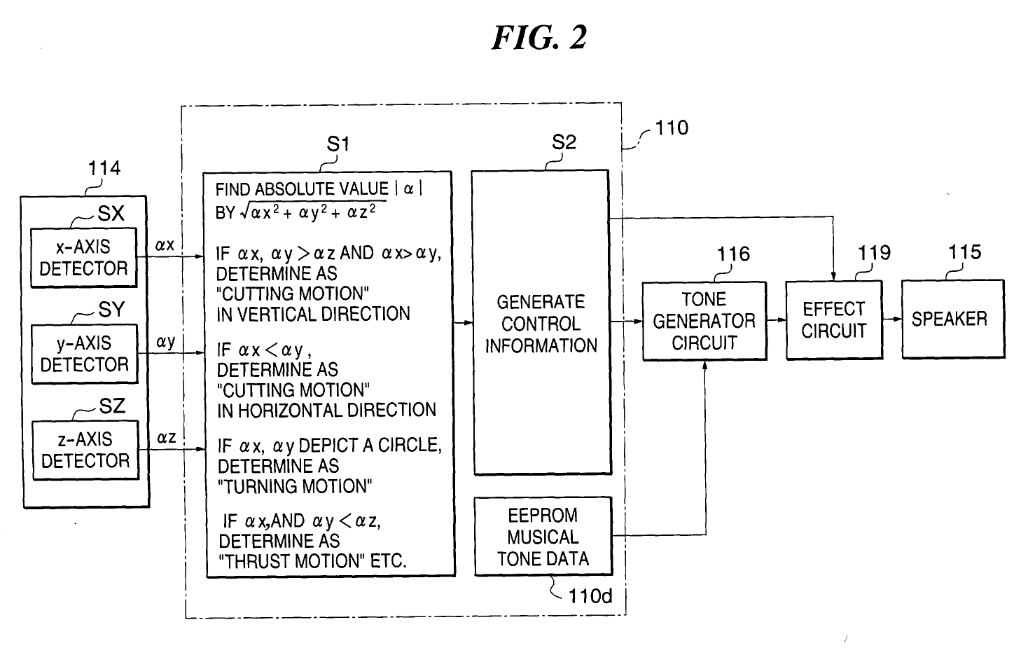

FIG. 2 is a view useful in explaining the operation of the cellular phone 11 in the motion-reflecting performance mode. When a three-dimensional acceleration sensor is used as the motion sensor 114, signals αx, αy, αz respectively indicating an acceleration αx in the x-axis (vertical: upward and downward) direction, an acceleration αy in the y-axis (horizontal: rightward and leftward) direction and an acceleration αz in the z-axis (horizontal: forward and backward) direction are detected by an x-axis detector SX, a y-axis detector SY and a z-axis detector SZ, respectively, of the motion sensor 114.

Upon receipt of acceleration data for the respective axes supplied from the motion sensor 114, the control section 110 analyzes the supplied acceleration data for each axis (step S1). In this analyzing process, first, an absolute value |α| of the acceleration which is expressed by the following formula (1) is obtained.

|α|=(αx*αx+αy*αy+αz*αz)^{1/2} (1)

Then, the accelerations αx, αy and the acceleration αz are compared with each other. When αx<αz and αy<αz hold, namely, when the z-axis direction acceleration αz is larger than either of the acceleration αx in the x-axis direction and the acceleration αy in the y-axis direction, the control section 110 determines that the motion of the user is a “thrust motion” thrusting the cellular phone 11 forward.

Conversely, when αx>αz and αy>αz hold, namely, the z-axis direction acceleration az is smaller than the x- and y-axis direction accelerations αx and αy, then the control section 110 determines that the motion of the user is a “cutting motion” cutting through the air with the cellular phone 11. In this case, by further comparing the x- and y-axis direction accelerations αx and αy in value, it is possible to determine whether the direction of the “cutting motion” is “vertical” (x) or “horizontal (y).

Further, in addition to a comparison of the x-, y-, and z-axis direction components with each other, it is possible to compare the magnitudes of the direction components αx, αy, and αz themselves with predetermined threshold values and determine that the motion is a “combined motion” combining these motions when the values are above the threshold values. For example, if αz>αx, αz>αy and αx>“threshold value of x-component”, it is determined that the movement is a “vertical (x-axis direction) cutting and thrusting motion”, while if αz<αx, αz<αy, αx>“threshold value of x-component”, and αy>“threshold value of y-component”, it is determined that the movement is an “obliquely(both x- and y-axis directions) cutting motion”. Further, by detecting a phenomenon that the values of the accelerations αx, αy in the x and y axis directions are changing relative to each other just like depicting a circular trajectory, it can be determined that the motion is a “turning motion” which turns the cellular phone 11 round and round, like a baton.

After thus analyzing the motion of the user made on the cellular phone 11 from the acceleration data supplied from the motion sensor 114, the control section 110 generates control information based on the contents of the analysis (step S2). What form of control information is to be generated based on the contents of the analysis may be determined as desired, a specific example of which will now be described.

First, the control section 110 generates volume control information that controls the volume of a musical tone to be generated in accordance with the absolute value |α| of the acceleration or the largest of the direction components αx, αy, and αz.

Also, the control section 110 generates the following control information based on the contents of the analysis. For example, the control section 110 generates control information that controls the tempo in accordance with the repetition period of a “vertical (x-axis direction) cutting motion”. Specifically, when a “vertical (x-axis direction) cutting motion” is detected at a high frequency, namely, when the user repeatedly makes a “vertical (x-axis direction) cutting motion” on the cellular phone 11 at a high frequency, the control section 110 generates control information designating a faster tempo of performance of a musical piece. Conversely, if a “vertical (x-axis direction) cutting motion” is detected at a low frequency, then the control section 110 generates control information designating a slower tempo of performance of the musical piece.

Further, when a “vertical cutting motion” is a quick and small motion, the control section 110 generates control information instructing to give an articulation. Conversely, when a “vertical cutting motion” is a slow and large motion, then the control section 110 generates control information designating a lower pitch. Further, if the motion of the user is a “horizontally (y-axis direction) cutting motion”, the control section 110 generates control information instructing to apply a slur effect. If it is determined that the motion is a “thrust motion”, the control section 110 generates not only control information instructing to apply a staccato effect in the same timing by shortening the tone generation duration, but also control information instructing to toss or insert a single tone (a tone of a percussion instrument, a shout or the like) into music performance into musical tones to be generated, according to the magnitude of the motion. If the motion is a “combined motion” combining a “cutting motion” and a “thrust motion”, the control section 110 generates control information instructing to make the above-described types of control in combination. In addition, if the motion is a “turning motion”, the control section 110 generates control information instructing to apply an enhanced reverberation effect according to the repetition period, and if its repetition period is short, control information instructing to generate a trill according to the repetition period.

The control information thus generated by the control section 110 is supplied to the tone generator circuit 116 and the effect circuit 119.

In addition to the above-described types of control, the control section 110 may provide various other types of control; for example, local peak values of the acceleration in the different axes, peak Q-values showing the sharpness of the local peaks, peak intervals showing the time intervals between local peaks, the depths of the valleys between local peaks, the intensities of high frequency components of the peaks, the polarities of the local peaks of the acceleration α(t), etc. are extracted, the beat timing of the music playediskontrolled in accordance with the time of occurrence of the peaks, the dynamics is controlled in accordance with the local peak values, and the articulation AR is controlled in accordance with the peak Q-values, etc.

While the control section 110 generates the control information corresponding to the motion of the user on the cellular phone 11 in the above-described manner, the CPU 110a reads musical tone data (here, MIDI data of a certain musical piece) stored in the EEPROM 110d of the control section 110 and supplies the read musical tone data to the tone generator circuit 116 whereby a musical tone signal is generated in accordance with the supplied MIDI data. On this occasion, the tone generator circuit 116 reflects a designation or instruction represented by the control information supplied from the control section 110. For example, the tone generator circuit 116 generates a musical tone signal whose musical tone parameters such as pitch and tone color are represented by the MIDI data and have been controlled based on volume control information generated in accordance with the absolute value |α| of the acceleration in the above-described manner and tempo/pitch control information generated according to the frequency of occurrence of a “cutting motion”. Further, if control information instructing to insert a single tone or the like is supplied, the tone generator circuit 116 adds to the musical tone signal generated based on the MIDI data another musical tone signal for producing the single tone and outputs the resulting combined musical tone signal. That is, in generating a musical tone signal based on the musical tone data stored in the EEPROM 110d, the tone generator circuit 116 provides control according to the control information supplied from the control section 110, namely, control to reflect a motion made by the user on the cellular phone 11.

The resulting musical tone signal thus generated by the tone generator circuit 116 is then supplied to the effect circuit 119, to which effect applying control information generated by the control section 110 is supplied. Upon receipt of such effect applying control information, the effect circuit 119 applies, to the musical tone signal supplied from the tone generator circuit 116, an effect or effects designated by the control information. For example, an effect such as reverberation is given to the musical tone signal supplied from the tone generator circuit 116, in accordance with the control information designating a reverberation effect determined by the magnitude of a “turning motion”. Consequently, a musical tone signal thus having been applied thereto the effect or effects corresponding to the control information by the effect circuit 119, namely, corresponding to the motion of the user on the cellular phone 11 is output to the sound speaker 115. As a result, musical tones which are not only faithful to the musical tone data stored in the EEPROM 110d but also reflect the motion of the user on the cellular phone 11 are output from the sound speaker 115.

As described above, according to the present embodiment, by making a motion on the cellular phone 11 capable of receiving communication services, such as telephone talking or data communication, of mobile communication networks, the user can reflect his or her motion on the cellular phone 11 during performance or reproduction of a piece of music or the like. According to the conventional technology, during performance or reproduction of a piece of music or the like, the user can do nothing but operate suitable control knobs or buttons to obtain a desired amount of volume or other performance parameters. On the other hand, according to the present embodiment, the user is not only provided with a function of faithfully performing or reproducing a piece of music or the like but also can be provided with a new style of enjoying music such that the user can actively participate in playing or reproduction of music. Further, according to the present embodiment, the user can be provided with the above new style of enjoying music by actively participating in generation of musical tones using the cellular phone 11 having a mobile phone function or the like. Thus, the user can easily enjoy music even at a place remote from his or her home or office without carrying dedicated equipment for musical tone generation.

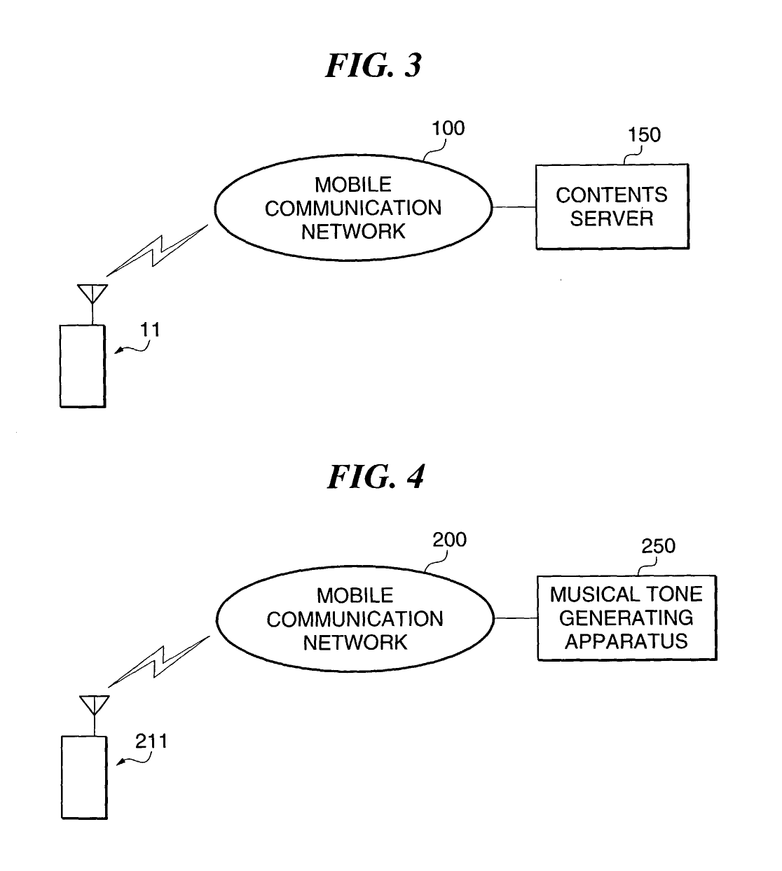

Further, according to the present embodiment, because the cellular phone 11 capable of receiving mobile communication services of mobile communication networks is used as a means with which the user can actively participate in musical tone generation, it is possible to easily enjoy performing various pieces of music by using a contents providing service, described later, using a mobile communication network. As shown in FIG. 3, a system in which the contents providing service is adoptediskomprised of the above-described cellular phone 11, a mobile communication network 100, and a contents server 150. Although the actual system includes a plurality of cellular phones, only one cellular phone 11 is shown here for clarity of illustration. Further, the contents server 150 is directly connected to the mobile communication network 100 in FIG. 3, but alternatively it may be connected to the mobile communication network 100 via another network, such as the Internet.

The contents server 150 stores a variety of pieces of musical tone data to be provided to the cellular phone 11. The musical tone data to be stored by the contents server 150 should by no means be limited to data for performance or reproduction of music (e.g., MIDI data, MP3-format (MPEG-1 Audio Layer-III) data) but may be data for generation of single tones such as wave sound or percussion instrument sound.

In the system of FIG. 3, when the user transmits a request for providing musical tone data to the contents server 150 from the cellular phone 11 via the mobile communication network 100 by operating the user interface section 113 of the cellular phone 11, musical tone data corresponding to the request is provided from the contents server 150 to the cellular phone 11 via the mobile communication network 100. At the cellular phone 11, the musical tone data provided from the contents server 150 is stored in the EEPROM 110d. The musical tone data thus obtained from the contents server 150 can be used to generate musical tones reflecting the motion of the user. It is therefore possible to easily obtain various pieces of musical tone data without any complicated operation of purchasing a portable recording medium such as CD-ROM (Compact Disk Read Only Memory) in which music data is recorded and obtaining the music data from the portable recording medium using a personal computer. Therefore, by merely carrying the cellular phone 11, the user can enjoy playing or reproduction of desired pieces of music even at a place remote from his or her home or office without always carrying a portable recording medium or the like in which data of his or her favorite pieces of music is recorded.

Next, a description will be given of a cellular phone according to a second embodiment of the present invention. FIG. 4 shows the schematic construction of a network system in which the cellular phone according to the second embodiment of the present invention is used. As shown in the figure, the network system is comprised of the cellular phone 211 according to the second embodiment, a mobile communication network 200 that provides radio communication services to cellular phones including the cellular phone 211, and a musical tone generating apparatus 250 connected to the mobile communication network 200. In FIG. 4, the mobile communication network 200 and the musical tone generating apparatus 250 are directly connected to each other. As an alternative, they may be connected to each other via another communication network, such as a fixed telephone network or the Internet. Anyhow, the network system may be of whatever arrangement that enables data communications between the cellular phone 211 and the musical tone generating apparatus 250 via the mobile communication network 200.

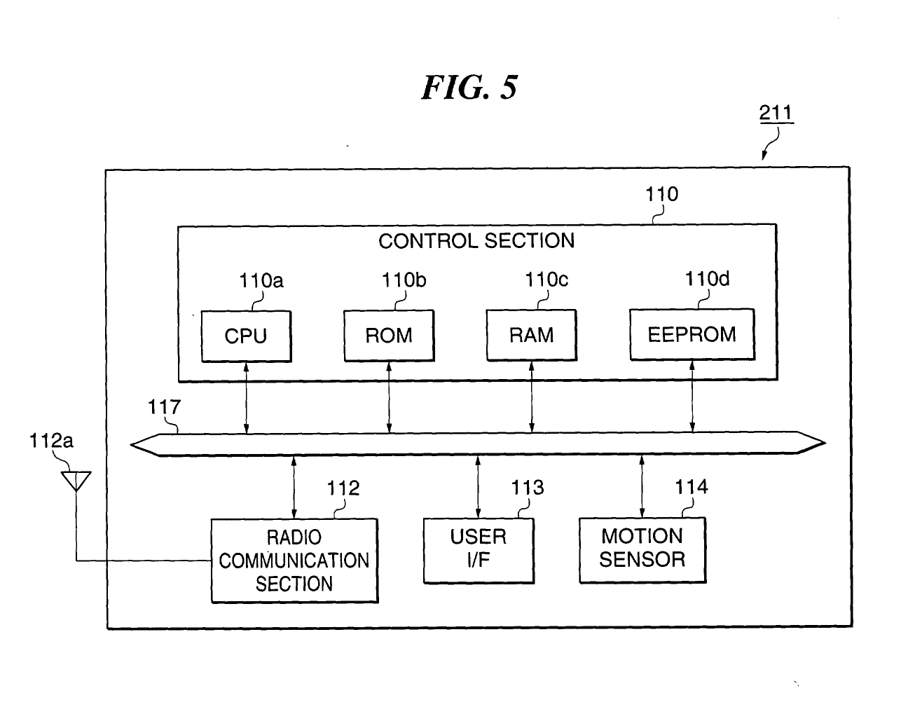

As shown in FIG. 5, the cellular phone 211 according to the second embodiment, like the cellular phone 11 according to the first embodiment, is comprised of a control section 110, a radio communication section 112, a user interface section 113, a motion sensor 114, and a bus 117 connecting these parts. The cellular phone 211 according to the second embodiment is identical in construction to the cellular phone 11 according to the first embodiment except that it is not provided with the sound speaker 115, the tone generator circuit 116 and the effect circuit 119.

That is, the cellular phone 211 according to the second embodiment does not have the function of generating musical tones based on MIDI data or other data. In the second embodiment, the cellular phone 211 does not serve to generate musical tones by itself, but it is used for the user to participate in musical tone generation performed by the musical tone generating apparatus 250 which is a separate apparatus from the cellular phone 211, based on MIDI data.

In order for the user to participate in the music tone generation by the music tone generating apparatus 250, the CPU 110a of the control section 110 in the cellular phone 211 performs the following processes in accordance with the control program stored in the ROM 110b of the control section 110.

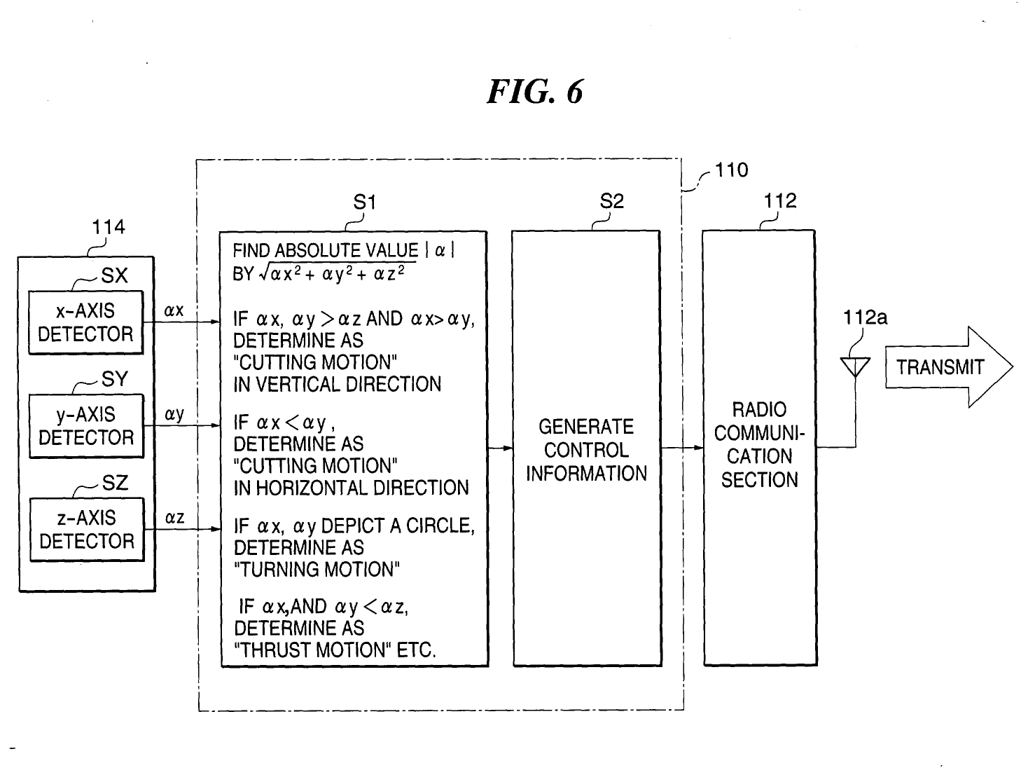

As shown in FIG. 6, as in the first embodiment, acceleration data of the respective axes x, y, z are supplied to the control section 110 from an x-axis detector SX, a y-axis detector SY and a z-axis detector SZ, respectively, of the motion sensor 114. The control section 110 analyzes the received acceleration data of the respective axes (step S1). This analyzing process is identical to that of the first embodiment described above with reference to FIG. 2, and description thereof is therefore omitted here.

After thus analyzing the motion of the user on the cellular phone 211 from the acceleration data supplied from the motion sensor 114, the control section 110 generates control information based on the contents of the analysis (step S2). This control information generating process is identical to that of the first embodiment described above with reference to FIG. 2, and description thereof is therefore omitted here.

In the cellular phone 211 according to the second embodiment, the control information generated by the control section 110 is supplied to the radio communication section 112. The radio communication section 112 transmits the control information generated by the control section 110 and hence corresponding to the result of detection of the motion of the user on the cellular phone 211, (detection result information) to the musical tone generating apparatus 250 via the mobile communication network 200. The control information thus transmitted from the cellular phone 211 via the mobile communication network 200 is used in controlling the musical tone generation at the musical tone generating apparatus 250.

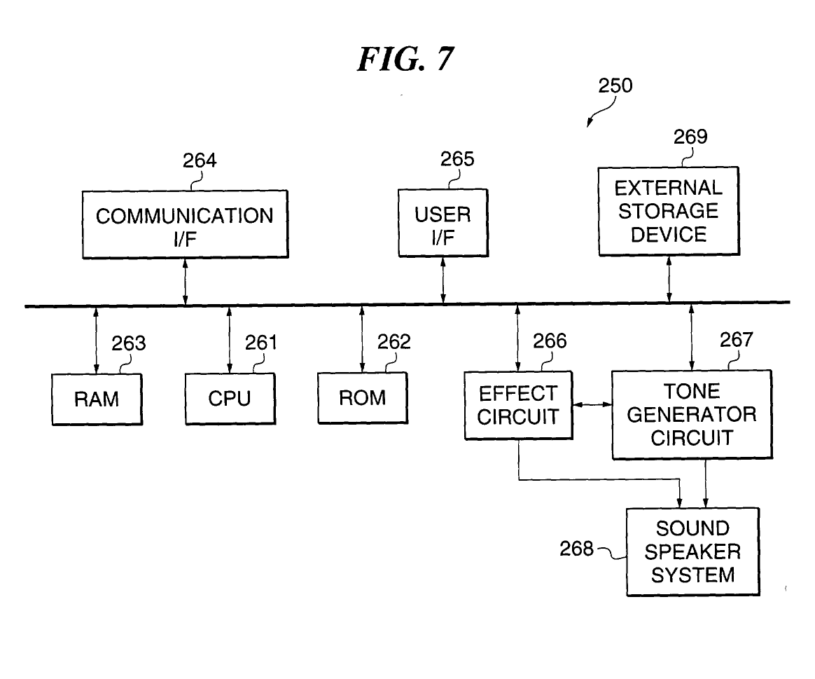

The musical tone generating apparatus 250 will now be described with reference to FIG. 7. As shown in the figure, the musical tone generating apparatus 250 is comprised of a CPU 261, a ROM 262, a RAM 263, a communication interface (I/F) 264, a user interface (I/F) 265, an effect circuit 266, a tone generator circuit 267, a sound speaker system 268, and an external storage device 269.

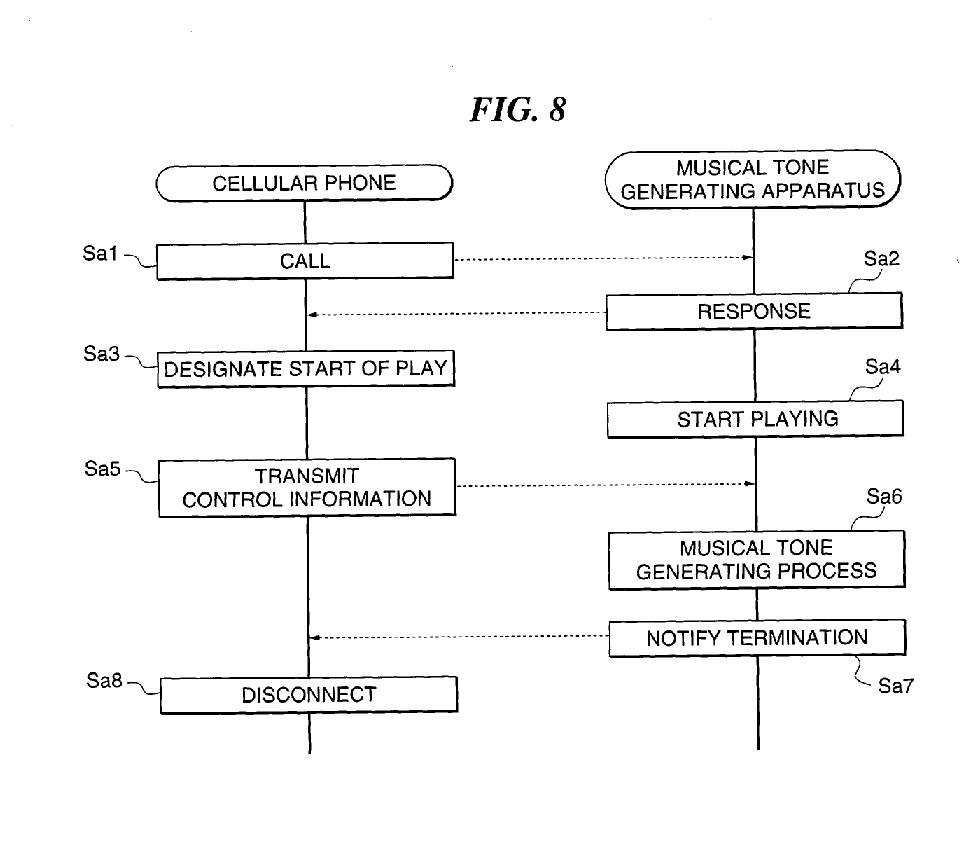

The CPU 261 performs various arithmetic processes and controls various parts of the musical tone generating apparatus 250. The RAM 263 serves as a work memory of the CPU 261. The ROM 262 stores various control programs to be read and executed by the CPU 261. The CPU 261 performs a musical tone generating process, described later (FIG. 8), which reflects the motion of the user on the cellular phone 211, by executing a control program stored in the ROM 262.

The external storage device 269 is composed of a hard disk drive (HDD), a compact disk read only memory (CD-ROM) drive or other storage device, and reads/stores musical tone data or other data from/into a recording medium. The musical tone data to be stored by the external storage device 269 is exemplified by MIDI data for performing/reproducing music and musical tone data for generating single tones such as wave sound and percussion instrument sound. The external storage device 269 may also store the above-described control programs.

The user interface 265 is comprised of a display for displaying various pieces of information, and a set of buttons by which the user makes input operations. The communication interface 264 is composed of a modem or router, and transmits and receives data with other equipment via a communication network. In the present embodiment, the communication interface 264 receives the control information transmitted from the cellular phone 211 via the mobile communication network 200 and loads the same into the musical tone generating apparatus 250, wherein the loaded control information is supplied to the CPU 261. The CPU 261 then supplies the control information supplied from the communication interface 264 to both the tone generator circuit 267 and the effect circuit 266.

The tone generator circuit 267 generates a musical tone signal based on the musical tone data stored in the external storage device 269. In thus generating a musical tone signal according to the musical tone data, the tone generator circuit 267 controls generation of the musical tone signal according the control information supplied from the CPU 261. For example, if the supplied control information designates a volume and a tempo, the tone generator circuit 267 generates a musical tone signal such that a musical tone having a pitch and tone color corresponding to the musical tone data (e.g., MIDI data) is produced with the volume and tempo designated by the control information, in the same manner as in the first embodiment. Thus, the tone generator circuit 267 generate a musical tone signal based on both the musical tone data stored in the external storage device 269 and the control information reflecting the motion of the user and supplied from the cellular phone 211 via the mobile communication network 200.

The effect circuit 266, which is composed of a digital signal processor (DSP), for example, applies desired effects such as reverberation, if necessary, to the musical tone signal generated by the tone generator circuit 267, and then outputs the resulting musical tone signal (or with no effect applied) to the sound speaker system 268. When control information for application of effects is supplied from the CPU 261, the effect circuit 266 applies one or more effects to the musical tone signal in accordance with the supplied control information. The sound speaker system 268 sounds musical tones in accordance with the musical tone signal supplied from the effect circuit 266.

As described above, according to the network system including the cellular phone 211 and the musical tone generating apparatus 250, by moving or making a motion on the cellular phone 211 by the user, it is possible to reflect the motion in the musical tone generation by the musical tone generating apparatus 250 located at a place remote (may be located at a close distance) from the cellular phone 211. The processing executed by the cellular phone 211 and the musical tone generating apparatus 250 in thus generating musical tones by the musical tone generating device 250 using the cellular phone 211 will now be described with reference to the sequence flow chart of FIG. 8.

As shown in FIG. 8, when musical tone generation is executed by the musical tone generating apparatus 250 located at a remote place from the cellular phone 211 using the cellular phone 211, the user suitably operates the cellular phone 211 for access to the musical tone generating apparatus 250, such that the cellular phone 211 a phone number for access to the musical tone generating apparatus 250 (step Sa1). Upon receipt of the call from the cellular phone 211, the musical tone generating apparatus 250 responds to the call and establishes a connection between the musical tone generating apparatus 250 and the cellular phone 211 via the mobile communication network 200. Upon the connection being established, the musical tone generating apparatus 250 reproduces a response guidance (in voice) or the like to start performance of a piece of music (step Sa2). The response guidance includes a message urging the user to select a piece of music for performance by operating ten keys and a message instructing the user to start performance of music by operating the ten keys.

When the user operates the ten keys to instruct performance of music in response to the voice guidance reproduced by the musical tone generating apparatus 250, the cellular phone 211 transmits a tone signal corresponding to the operation, to the musical tone generating apparatus 250 via the mobile communication network 200 (step Sa3). Upon receipt of the tone signal designating start of music, the musical tone generating apparatus 250 starts a performance process designated by the tone signal (step Sa4), and waits for control information to be supplied from the cellular phone 211. More specifically, the musical tone generating apparatus 250 reads from the external storage device 269 musical tone data of the piece of music designated by the tone signal, and generates a musical tone signal based on the read musical tone data.

Upon the start of performance of music by the musical tone generating apparatus 250, the user moves the cellular phone 211 so as to reflect his or her motion in the performance of music. The cellular phone 211 thereby generates control information corresponding to the motion of the user and transmits the generated control information to the musical tone generating apparatus 250 via the mobile communication network 200 (step Sa5). Upon receipt of the control information supplied from the cellular phone 211 during the musical tone generating process, the musical tone generating apparatus 250 generates a musical tone signal based not only on the read musical data but also on the received control information, and sounds musical tones through the sound speaker system 268 (step Sa6). It is thus possible to control musical tones generated by the musical tone generating apparatus 250, by operating the cellular phone 211 located at a place remote from the musical tone generating apparatus 250.

Upon termination of the musical tone generating process based on the musical tone data, the musical tone generating apparatus 250 notifies the user of the termination of the musical tone generating process by a voice guidance or the like (step Sa7), and when the user depresses an on-hook button or the like on the cellular phone 211 to disconnect the communication line between the cellular phone 211 and the musical tone generating apparatus 250 via the mobile communication network 200 (step Sa8). Thus, the musical tone generating process reflecting the motion of the user, who carries the cellular phone 211 at a place remote from the musical tone generating apparatus 250, in the music performance by the musical tone generating apparatus 250 is terminated.

As described above, according to the celllular phone 211 of the present embodiment, by the user making a motion on the cellular phone 211 capable of receiving communication services, such as telephone talking and data communication, of mobile communication networks, it is possible to reflect the motion of the user in performance and reproduction of music or the like by the musical tone generating apparatus 250 located at a place remote (may be located at a close distance) from the cellular phone 211. Therefore, even if the cellular phone 211 is located remotely from the musical tone generating apparatus 250, it is possible to provide the user with a new style of enjoying music such that the user can actively participate in the music tone generation by the music tone generating apparatus 250, using the cellular phone 211 having a mobile phone function or the like.

It should be noted that the musical tone generating apparatus 250 may have a function of performing simultaneous communications with a plurality of cellular phones 211 so that musical tones can be controlled according to control information transmitted from the plurality of cellular phones 211. Further, if the musical tone data stored in the external storage device 269 of the musical tone generating apparatus 250 is music data comprised of a plurality of parts, different cellular phones 211 may be allocated to the respective parts so that the control information transmitted from each cellular phone 211 allocated to each part can be reflected in the control of musical tone generation for the part.

Further, in the above-described second embodiment, the cellular phone 211 generates control information representing the result of detection (signals αx, αy, αz if the motion sensor 114 is a three-dimensional acceleration sensor) corresponding to the motion of the user on the cellular phone 211, and transmits the generated control information to the musical tone generating apparatus 250 via the mobile communication network 200. Alternatively, detection result data representing the signals αx, αy, αz as the result of detection by the motion sensor 114 may be transmitted to the musical tone generating apparatus 250 via the mobile communication network 200, that is, the cellular phone 211 does not generate the control information. Instead, the musical tone generating apparatus 250 may generate the control information based on the received the detection result data representing the accelerations αx, αy, αz, for use in controlling the musical tone generation.

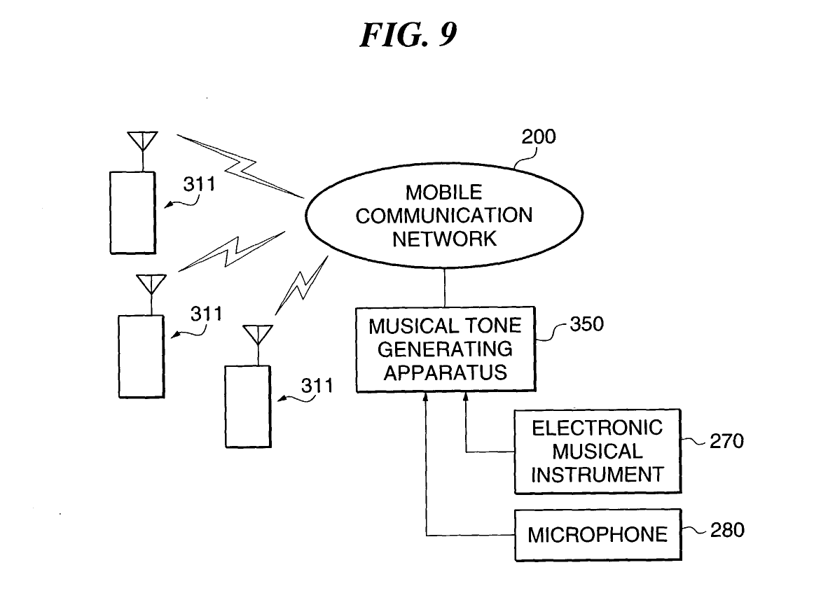

Next, a description will be given of a musical tone generating system according to a third embodiment of the present invention. FIG. 9 shows the musical tone generating system according to the third embodiment of the present invention. The musical tone generating system according to the third embodiment provides a new entertainment of a listener-participating type for a concert site or a like place, by utilizing the technology of the second embodiment, namely, controlling the musical tone generation by a remotely located musical tone generating apparatus using a cellular phone. The schematic construction of the musical tone generating system according to the third embodiment is illustrated in FIG. 9.

As shown in FIG. 9, the musical tone generating system according to the third embodiment for providing the listener-participating type entertainment to be held in a concert site is comprised of a plurality of cellular phones 311 carried by many listeners in the concert site, a mobile communication network 200, a musical tone generating apparatus 350 installed in the concert site, an electronic musical instrument 270 used by a player, and a microphone 280 used by a singer.

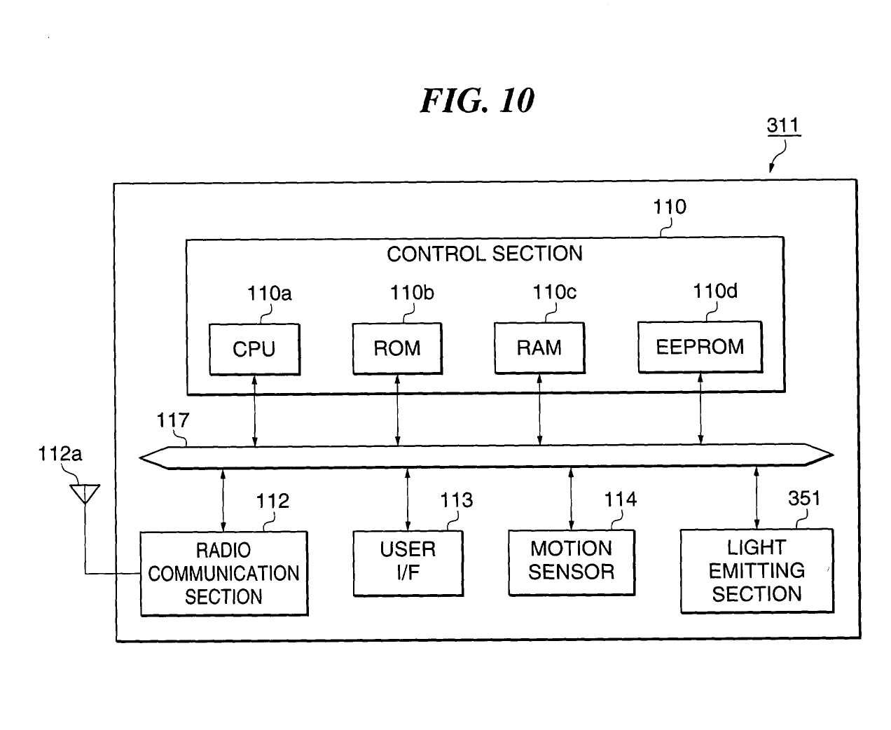

As shown in FIG. 10, the cellular phone 311 includes a light-emitting section (notifying device) 351 comprised of a plurality of light emitting devices such as LEDs (Light Emitting Diodes), for example, in addition to a control section 110, a radio communication section 112, a user interface section 113 and a motion sensor 114, which are identical in function to the corresponding parts of the cellular phone 211 of the second embodiment described above.

Each of the cellular phones 311, like the cellular phone 211 of the second embodiment, generates control information corresponding to the motion of the listener as the user and has the function of transmitting the generated control information to the musical generating apparatus 350 via the mobile communication network 200. Further, in the cellular phone 311, the radio communication section 112 receives light-emission instructing data supplied from the musical tone generating apparatus 350 via the mobile communication network 200, and the control section 110 drives the light emitting section 351 according to the received light-emission instructing data.

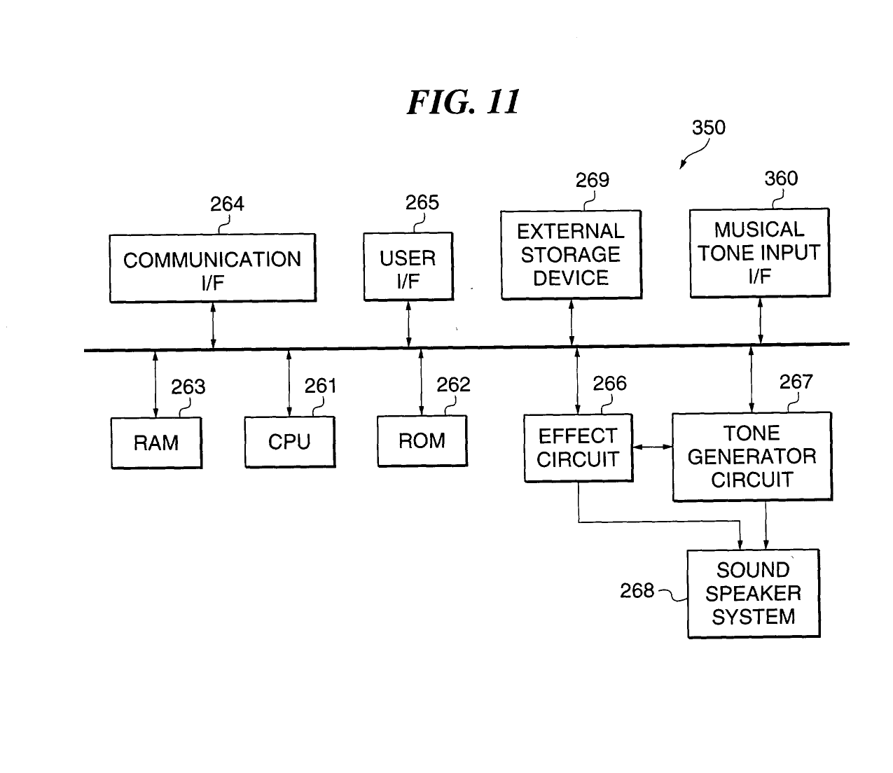

As shown in FIG. 11, the musical tone generating apparatus 350 includes a musical tone data input interface (I/F) 360, in addition to a CPU 261, a ROM 262, a RAM 263, a communication interface 264, a user interface 265, an effect circuit 266, a tone generator circuit 267, a sound speaker system 268 and an external storage device 269 which are identical in function to the corresponding parts of the cellular phone 211 of the second embodiment described above.

In the musical tone generating system according to the third embodiment, musical tone data (second musical tone information) generated by the electronic musical instrument 270, with which a player plays music, and singing voice data (second musical tone information) generated by the microphone 280, to which a singer inputs his or her singing voice, are transmitted to the musical tone generating apparatus 350 by a wired or radio communication means. The musical tone data input interface (musical tone information obtaining means) 360 serves as an interface through which these musical tone data are input to the musical tone generating apparatus 350.

The musical tone generating apparatus 350, as is distinct from the musical tone generating apparatus 250 of the above-described second embodiment, generates musical tones based on the musical tone data supplied from the electronic musical instrument 270 and the microphone 280 instead of the musical data stored in the external storage device 269. Namely, the musical tone generating apparatus 350 sounds, in the concert cite, musical tones of music played by the player and the singing voice of the singer through the sound speaker system 268. Alternatively, musical tone data (second musical tone information) may be previously stored in the external storage device 269 so that musical tones can be generated based on the stored musical tone data.

In generating musical tones in accordance with the performance by the player and the singing by the singer, the musical tone generating apparatus 350 reflects various pieces of control information transmitted from the cellular phones 350 of many listeners. For this purpose, the musical generating apparatus 350 is equipped with a large number of communication lines for access to the musical generating apparatus 350 so that simultaneous data communications can take place between the musical generating apparatus 350 and many cellular phones 311.

Further, in the external storage device 269 of the musical tone generating apparatus 350, a table is stored in which various pieces of information for identifying pieces of music intended to be played in the concert and light-emission instructing data are correlated. The light-emission instructing data is transmitted to the cellular phones 311 which is connected to the musical tone generating apparatus 350 via the mobile communication network 200, when the musical tones of a corresponding piece of music are generated. The light-emission instructing data is used to control the timing and manner (which of a plurality of light emitting devices should be energized to emit light) of light emission of the light emitting section 351 mounted on each of the cellular phones 311.

To start performance of a certain piece of music by the player and the singer, concert staff inputs a performance start instruction to the musical tone generating apparatus 350 via the user interface 265. In response to the input of the performance start instruction, the CPU 261 of the musical tone generating apparatus 350 executes a control process of reading light-emission instructing data corresponding to the piece of music from the external storage device 269 and transmitting the read light-emission instructing data to the cellular phones 311 connected to the musical tone generating apparatus 350. The light-emission instructing data is thus transmitted from the communication interface 264 via the mobile communication network 200 to the cellular phones 311 connected to the network 200.

A description will now be given of the operation of the musical tone generating system according to the present embodiment when listeners participate in performance of music in accordance with the performance by the player and the singing by the singer. First, when in the concert site performance of a certain piece of music by the player and singing by the singer are started, musical tone data is supplied from the electronic musical instrument 270 and the microphone 280 to the musical tone generating apparatus 350. Then, the musical tone generating apparatus 350 generates musical tone signals based on the received musical tone data, and musical tones corresponding to the generated musical tone signals are sounded by the sound speaker system 268. The performance of the piece of music is thereby started.

After the music performance in accordance with the performance by the player and the singing by the singer has thus been started, various pieces of control information from the cellular phones 311 of many listeners are transmitted to the musical tone generating apparatus 350, and the musical tone generating apparatus 350 controls the generation of musical tones in accordance with the performance by the player and the singing by the singer, according to the received control information.

More specifically, each listener operates his or her cellular phone 311 to make a call to a predetermined phone number for access to the musical tone generating apparatus 350. When the musical tone generating apparatus 350 responds to the call and connects the communication line between the cellular phone 311 and the musical tone generating apparatus 350 via the mobile communication network 200, control information (detection result information) corresponding to the motion of the user is transmitted to the musical tone generating apparatus 350 from his or her cellular phone 311, whereas, light-emission instructing data corresponding to the piece of music being performed and sung is transmitted to the cellular phone 311 from the musical tone generating apparatus 350. The cellular phone 311 having received the light-emission instructing data transmitted from the musical tone generating apparatus 350 drives the light emitting section 351 in accordance with the received light-emission instructing data. Thus, in the present embodiment, the musical tone generation by the musical tone generating apparatus 350 is controlled in accordance with the motions of the listeners. To this end, the light-emission instructing data has such contents that a model motion to be followed by listeners according to the piece of music being performed is notified to the listeners. This light-emission instructing data is exemplified by data causing the light emitting section 351 to emit light in timing in which the listener is desired to largely swing his or her cellular phone 311. If the light emitting section 351 is comprised of a plurality of light emitting devices, a model motion can be notified to the listeners by selectively causing the light emitting devices to emit light. For example, in the case where there is provided a rule that if only one of a pair of light emitting devices is made to emit light, a horizontal swinging motion should be notified, and if the both light emitting devices are made to emit light, a vertical swing motion should be notified, light-emission instructing data may be used that instructs the light emitting section 351 to be energized in timing in which the horizontal swinging motion should be made.

From the above-described manner of light emitting of the light emitting section 351 based on the light-emission instructing data, the listeners can learn what motion should be made in what timing so that he or her can easily make a motion corresponding to the notified contents. The listeners move their cellular phones 311 according to the notified contents, the cellular phones 311 generate control information and the generated control information is supplied to the musical tone generating apparatus 350.

For example, if the control information transmitted from a cellular phone 311 to the musical tone generating apparatus 350 instructs to apply an increased reverberation effect to the musical tones of the singing, the musical tone generating apparatus 350 performs signal processing so as to apply an increased reverberation effect to the singing tone signal, and outputs the resulting singing tone signal through the sound speaker system 268. If the control information transmitted from a cellular phone 311 instructs to insert a single tone, such as a clap and a shout, the musical tone generating apparatus 350 adds a musical tone signal for generating such a single tone, to the musical tone signal corresponding to the performance by the player and the singing by the singer, and outputs the resulting combined musical tone signal through the sound speaker system 268. In this way, the musical tone generation is controlled in accordance with control information supplied from the cellular phones 311 of many listeners, namely, motions of many listeners on their cellular phones 311.

Further, when the musical tone generating apparatus 350 thus generates musical tones in accordance with control information transmitted from the cellular phones 311 of many listeners, different kinds of control information can be transmitted simultaneously. To cope with this, the musical tone generating apparatus 350 is constructed such that pieces of control information that can be processed are extracted at random from many pieces of control information received within a certain fixed period of time, and the musical tone generation is controlled using the extracted control information.

The control information to be used for control of the musical tone generation should by no means be limited to the thus extracted control information> Alternatively, among many pieces of control information received within a certain fixed period of time (e.g., three seconds), the maximum number of pieces of control information identical in instruction contents may be used. For example, if control information instructing to apply an increased reverberation effect to the musical tones of the singing has been received in the maximum number of pieces within a fixed period of time, a process of increasing the reverberation effect of the musical tones of the singing is carried out in accordance with the control information received in the maximum number of pieces after the lapse of the fixed period of time and until the lapse of the next fixed period of time. Generation of the control information identical in instruction contents by cellular phones 311 means that many listeners holding their cellular phones 311 have made a substantially identical motion. By using the control information received in the maximum number of pieces, it is possible to control the musical tone generation in a manner reflecting the motions of most listeners.

Further, the musical tone generation for every part of a piece of music performed by players and singers, such as guitar, bass and vocal, may be controlled using the control information transmitted from the cellular phones 311 of the listeners. Specifically, different phones numbers for access to respective different musical tone generating apparatuses are allocated in advance for every part, such as guitar, bass and vocal, and control information transmitted from cellular phones 311 which are connected via a network to a musical tone generating apparatus 350 using the allocated phone number, is used to control the generation of musical tones for the corresponding part. For example, when a musical tone signal corresponding to the guitar part is to be generated, a particular musical tone generating apparatus 350 uses control information transmitted from cellular phones 311 which are connected via the network with the particular musical tone generating apparatus 350 using the phone number allocated to the guitar part. When a musical tone signal corresponding to the vocal part is to be generated, another particular musical tone generating apparatus 350 uses control information transmitted from cellular phones 311 which are connected via the network with the particular musical tone generating apparatus 350 using the phone number allocated to the vocal part.

Although in the above-described third embodiment, the cellular phones 311 carried by the listeners each have a light emitting section 351, and upon receipt of the light-emission instructing data transmitted from the musical tone generating apparatus 350, the light emitting section 351 is caused to emit light so as to notify the listener of a model motion corresponding to performance of a piece of music, various other methods may be used in notifying the listeners of the model motion. For example, notification of the model motion to the listeners may be realized by causing the liquid crystal display (LCD) of each of the cellular phones 311 to emit light or display the contents of the model motion. In this case, the musical tone generating apparatus 350 may transmit to each cellular phone 311 data for causing the LCD of the cellular phone 311 to emit light or make a display in accordance with the contents to be notified to the listener carrying the cellular phone 311.

Further, although in the third embodiment, the light emitting section 351 of each cellular phone 311 emits light based on the light-emission instructing data transmitted from the musical tone generating apparatus 350, alternatively, the control section 110 of the cellular phone 311 may drive the light emitting section 351 to emit light in accordance with the result of detection by the motion sensor 114. For example, the control section 110 of the cellular phone 311 may provide control such that that the light emitting section 351 emits light when the motion sensor 114 detects a large motion which is larger than a predetermined value (for example, the detected acceleration exceeds a predetermined value).

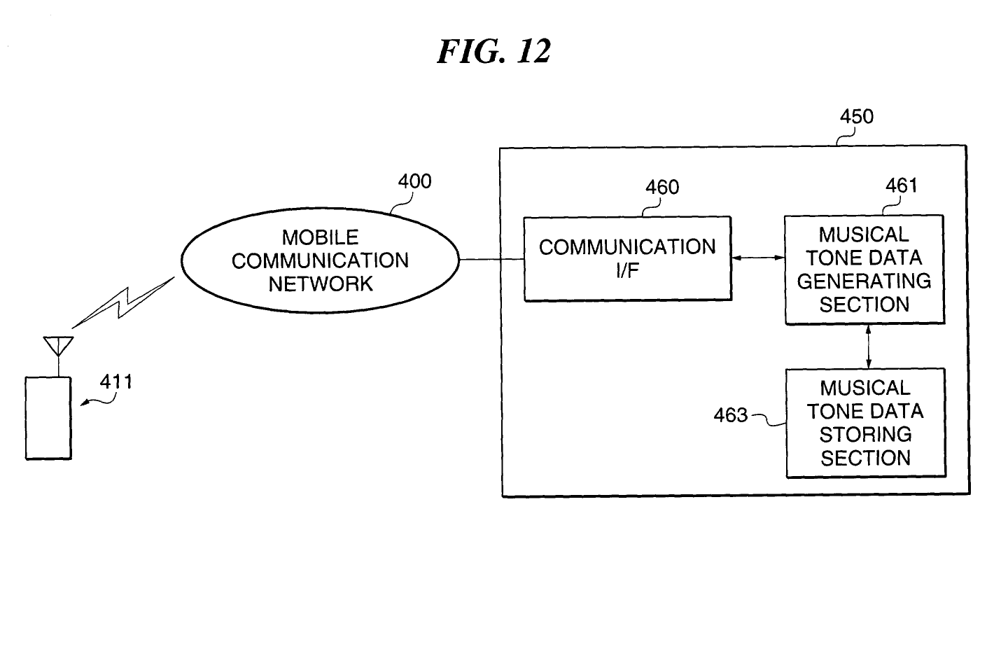

FIG. 12 shows the schematic construction of a network system for realizing a musical tone data providing service using a musical tone data providing method according to a fourth embodiment of the present invention. As illustrated in FIG. 12, the network system is comprised of a cellular phone 411, a mobile communication network 400 providing a radio communication service to the cellular phone 411, and a musical tone data providing server (musical tone generating apparatus) 450 connected to the mobile communication network 400. In FIG. 12, the musical tone data providing server 450 and the mobile communication network 400 are directly connected to each other, but alternatively they may be connected to each other via another network, such as a fixed-telephone network or the Internet.

The musical tone data providing server 450 is a computer system in the form of a personal computer or a workstation. The musical tone data providing server 450 is constructed such that by having a CPU thereof execute a control program stored in a built-in storage means thereof, such as a hard disk drive upon receipt of a request for providing musical tone data from the cellular phone 411 via the mobile communication network 400, the musical tone data providing server 450 transmits the musical data to the cellular phone 411 in response to the received request (musical tone data transmitting process).

As shown in FIG. 12, the musical data providing server 450 is comprised of a communication interface (I/F) 460, a musical data generating section 461, and a musical tone data storing section 463.

The communication interface 460 transmits and received data between the musical tone data providing server 450 and external equipment and transmits and receives various kinds of data to and from the cellular phone 411 via the mobile communication network 400. When making a request for providing musical tone data, the user of the cellular phone 411 calls to a predetermined phone number for access to the musical tone data providing server 450 to establish a connection between the musical tone data providing server 450 and the cellular phone 411. Using the established connection, the cellular phone 411 transmits and receives various requests, detection result data, musical tone data, described later, etc. to and from the musical tone data providing server 450.

The musical tone data storing section 463, which is composed of a hard disk drive (HDD) or the like, stores music data (MIDI data, audio data of CD-DA (CD Digital Audio) format, etc.) for performing a large number of pieces of music, and musical tone data for generating single tones, such as percussion instrument sound, wave sound or wind sound.

Upon receipt of a musical tone data providing request from the cellular phone 411 via the communication interface 460, the musical tone data generating section 461 reads musical data corresponding to the request from the musical tone data storing section 463, generates a musical tone signal based on the read musical tone data and the detection result data supplied from the cellular phone 411 from which the request has been made, and transmits the generated musical tone signal to the cellular phone 411 via the communication interface 460. More specifically, upon receipt of the providing request, which contains information for identifying a piece of music to be provided, from the cellular phone 411 via the mobile communication network 400, the musical data generation section 461 reads from the musical tone data storing section 463 musical tone data of the piece of music to be provided. Then, the musical tone data generating section 461 generates a musical tone signal based on the read musical tone data of the piece of music, and transmits the generated musical tone signal in a predetermined compressed format (e.g., MP3 format) to the cellular phone 411 via the communication interface 460. Thus, the musical tone data generating section 461 transmits a musical tone signal for performing the requested piece of music to the request-source cellular phone 411, and during that time, generates control information for controlling the musical tone signal generation from the detection result data transmitted from the cellular phone 411, whereupon, using the generated control information, the musical tone data generating section 461 generates a musical tone signal from the musical tone data read from the musical tone data storing section 463. The generated control information, as in the above-described embodiments, reflects the motion of the user on the cellular phone 411, described later, which motion has been detected by the motion sensor 114, and controls generation of various musical tone signals, such as volume, tempo, insertion of a single tone, application of a reverberation effect, etc.

In this way, the musical tone data generating section 461 reads musical tone data from the musical tone data storing section 463, and generates a musical tone signal based on the read musical tone data and the control information generated in accordance with the detection result data supplied from the cellular phone 411. The musical tone data generating section 461 then transmits the generated musical tone signal to the cellular phone 411 via the communication interface 460.

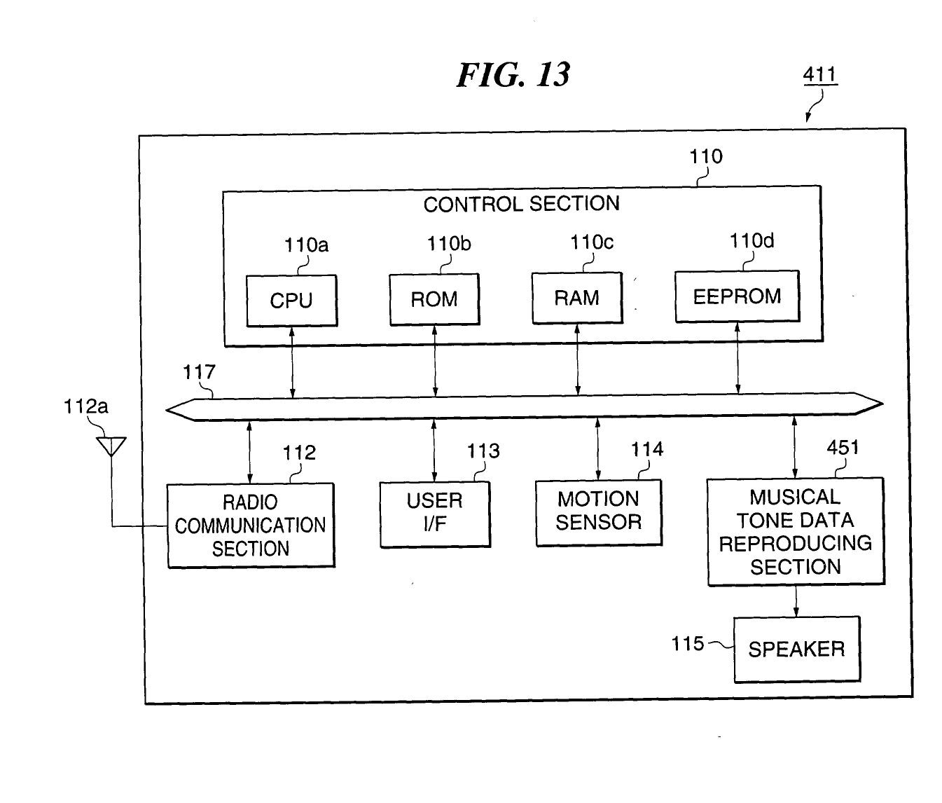

The cellular phone 411, which is capable of making the above-described musical tone data providing request, will now be described with reference to FIG. 13. As shown in FIG. 13, the cellular phone 411 includes a musical data reproducing section 451, in addition to a control section 110, a radio communication section 112, a user interface section 113, a motion sensor 114 and a sound speaker 115, which are identical in function to the corresponding parts of the cellular phone 11 of the first embodiment,.

The musical tone data reproducing section 451 decodes the musical tone signal in MP3 format or the like and outputs the resulting musical tone signal to the sound speaker 115. The musical data reproducing section 451 enables music performance by decoding a MP3-format musical tone signal, which is stored in the EEPROM 110d. In the cellular phone 411 according to the fourth embodiment, the musical data reproducing section 451 also enables generation of a musical tone signal by decoding the compressed musical tone signal transmitted from the musical tone data providing server 450 in the above-described manner.

In the above-described way, the cellular phone 411 enables music performance by receiving the musical tone signal transmitted from the musical tone data providing server 450 and reproducing the received musical tone signal. On this occasion, the cellular phone 411 can reflect the motion of the user on the cellular phone 411 in the music performance based on the musical tone signal transmitted from the musical tone data providing server 450. To thus enable the user to participate in the music performance, while the cellular phone 411 is connected to the musical tone data providing server 450 to receive musical tone data therefrom, the control section 110 of the cellular phone 411 performs the following processing in accordance with a control program, which is stored in the ROM 110b. First, the control section 110, as in the above-described first embodiment, periodically obtains acceleration data of the respective axes x, y, z, from an x-axis detector SX, a y-axis detector SY and a z-axis detector SZ of the motion sensor 114, converts the obtained acceleration data, which represent the result of detection by the motion sensor 114, into a predetermined format suitable for data communication with the musical tone data providing server 450, and outputs the converted data to the radio communication section 112. The detection result data corresponding to the motion of the user on the cellular phone 411, which motion is detected by the motion sensor 114, is thereby transmitted to the musical tone data providing server 450 from the cellular phone 411 via the mobile communication network 400.

Next, a description will be given of the operation of the thus configured network system when the cellular phone 411 requests the musical tone data providing server 450 to provide musical data reflecting the motion of the user

First, the user operates ten keys, for example, of the cellular phone 411 to call to a phone number for access to the musical tone data providing server 450. Upon receipt of the call from the cellular phone 411, the musical tone data providing server 450 establishes a connection between the musical tone data providing server 450 and the cellular phone 411 via the mobile communication network 400. Having thus established the connection, the musical tone data providing server 450 reproduces a response guidance or the like to start performance of a piece of music. The response guidance includes a message urging the user to select a piece of music for performance by operating ten keys and a message instructing the user to start performance of music by operating the ten keys. The response guidance may include an explanation as to what type of motion should be made and how such type of motion should be reflected in the performance of music.

When the user operates the ten keys to instruct performance of a certain piece of music in response to the voice guidance reproduced by the musical tone data providing server 450, the cellular phone 411 transmits a tone signal corresponding to the operation to the musical tone data providing server 450 via the mobile communication network 400. Upon receipt of such tone signal designating the start of music, the music tone data providing server 450 reads musical tone data of a piece of music represented by the received tone signal from the musical tone data storing section 463, starts generating a musical tone signal based on the musical tone data, and transmits the generated musical tone signal to the cellular phone 411 via the mobile communication network 400. While thus starting the transmission of the musical tone signal, the musical tone data providing server 450 waits for control information to be transmitted from the cellular phone 411.

When control information from the cellular phone 411 is transmitted to the musical tone data providing server 450 following the start of transmission of the musical tone signal from the musical tone data providing server 450 to the cellular phone 411, the musical tone data providing server 450 controls the musical tone signal based on the musical tone data read in accordance with the received control information. Namely, while the control information corresponding to the motion of the user is transmitted from the cellular phone 411 to the musical tone data providing server 450, the musical tone signal corresponding to the control information is transmitted from the musical tone data providing server 450 to the cellular phone 411. For example, if the instruction contents of the control information transmitted to the musical tone data providing server 450 from the cellular phone 411 is to increase the reverberation effect, the musical tone data providing server 450 performs signal processing so as to apply an increased reverberation effect to the musical tone signal during generation of the musical tone signal based on the read musical tone data and transmits the resulting musical tone signal to the cellular phone 411. The musical tone signal thus transmitted from the musical tone data providing server 450 is reproduced by the musical tone data reproducing section 451 of the cellular phone 411 and is sounded through the sound speaker 115 of the cellular phone 411.

As described above, according to the present embodiment, when the user of the cellular phone 411 has accessed the musical tone data providing server 450 to designate a desired piece of music, performed musical tones of the designated piece of music reflecting the motion of the user are sounded in real time through the sound speaker 115 of the cellular phone 411 carried by the user. According to the conventional technology, during performance or reproduction of a piece of music or the like, the user can do nothing but operate suitable control knobs or buttons to obtain a desired amount of volume or other performance parameters. On the other hand, according to the present embodiment, the user is not only provided with a function of faithfully performing or reproducing a piece of music or the like but also can be provided with a new style of enjoying music such that the user can actively participate in playing or reproduction of music.

Further, according to the present embodiment, the user can be provided with the above new style of enjoying music by actively participating in generation of musical tones using the cellular phone 411 having a mobile phone function or the like. Thus, the user can easily enjoy music even at a place remote from his or her home or office without carrying dedicated equipment for musical tone generation.

Furthermore, the control of the musical tone signal reflecting the motion of the user is performed not by the cellular phone 411 but by the musical tone data providing server 450, while the cellular phone 411 has only to reproduce the musical tone signal, whereby musical tones reflecting the motion of the user can be generated. Therefore, the cellular phone 411 does not require any component parts for analyzing the motion of the user and generating control information, thereby enabling designing the cellular phone 411 simple in construction.

The present invention should by no means be limited to the above-described embodiments, and various variations may be made as follows.

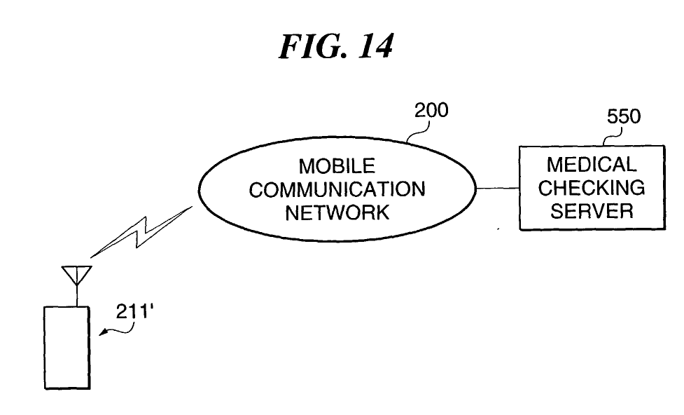

In the above-described second embodiment, the musical tone generation by the musical tone generating apparatus 250 is controlled by the cellular phone 211 generating control information corresponding to the motion of the user, and transmitting the generated control information to the musical tone generating apparatus 250 via the mobile communication network 200. Information corresponding to the motion of the user generated by the cellular phone 211 may be used for applications other than the musical tone generation. For example, as shown in FIG. 14, a cellular phone 211′ may be used in a network system that remotely controls health conditions of aged persons or rehabilitated persons.

As shown in FIG. 14, the network system is comprised of the cellular phone 211′ carried by a person whose health condition is to be checked, a mobile communication network 200 that provides the cellular phone 211′ with radio communication services, and a medical checking server 550 connected to the mobile communication network 200. In the figure, the medical checking server 550 and the mobile communication network 200 are directly connected to each other. Alternatively, the medical checking server 550 and the mobile communication network 200 may be connected to each other via another communication network, such as a fixed telephone network or the Internet.

The cellular phone 211′ according to this variation, like the cellular phone 211 according to the second embodiment, is equipped with a motion sensor 114 and is identical to the cellular phone 211 in that the motion sensor 114 detects the motion or physical posture of a user whose health condition is checked carrying the cellular phone 211′. But, unlike the cellular phone 211, the cellular phone 211′ according to the variation does not generate control information for controlling the musical tone generation. Specifically, the cellular phone 211′ converts information representing the result of detection by the motion sensor 114 (signals αx, αy, αz, if the motion sensor 114 is a three-dimensional acceleration sensor), into detection result data of a format conforming to data communication with the medical checking server 550, and transmits the resulting detection result data to the medical checking server 550 via the mobile communication network 200. Thus, the mobile communication network 200 is used for transmission of the detection result data from the cellular phone 211′ to the medical checking server 550. Ideally, the cellular phone 211′ is always kept connected with the medical checking server 550 to transmit the detection result data. However, to save communication fees, the cellular phone 211′ may be connected to the medical checking server 550 at regular time intervals to transmit the detection result data to the medical checking server 550 intermittently. In this intermittent transmission, detection result data may be temporarily stored in the cellular phone 211′ for a predetermined period of time, and when a transmission time is reached, the stored detection result data may be transmitted in one lump. This intermittent transmission of the detection result data might encounter too-late checking at the medical checking server 550 if an abnormality occurs with a person to be medically checked during the above predetermined period of time. To avoid this, the cellular phone 211′ may be provided with a function of discriminating whether or not the detection result data contains an abnormality (a very large acceleration that cannot be found with a normal physical movement, if the motion sensor is a three-dimensional acceleration sensor). If the result of this discrimination is positive, then the cellular phone 211′ may transmit the detection result data in question to the medical checking server 550 immediately.

The medical checking server 550 is composed of a personal computer, for example, in which a CPU executes a control program stored in a built-in storage device, thereby realizing a medical checking process as described below.

The medical checking server 550 stores detection result data, which is transmitted from the cellular phones 211′ via the mobile communication network 200, in a database or the like for every person to be medically checked, thereby managing physical conditions for each person to be medically checked. By displaying the detection result data in time series in response to an manager's instruction, it is possible to notify the manager of physical conditions for every person to be medically checked.

As described above, acccording to the present medical checking network system, the detection result data representing the motions of the persons to be medically checked, which the persons have made on the cellular phones 211′ carried by the persons, are stored in a database or the like, and by referring to the contents stored in the database or the like, the manager can learn about the status of motions of the persons to be medically checked. Further, a timetable showing what degree of motion and at what time a person to be medically checked should make may be predetermined by and between the manager and the person to be medically checked, for use in remote control of the status of motion by the manager by checking whether or not the person to be medically checked has made a predetermined degree of motion at a predetermined time, by simply referring to a display or the like of the medical checking server 550 located at a remote place. If the person to be medically checked has not made the predetermined degree of motion at the predetermined time, the manager can warn the person about his or her failure by calling the cellular phone 211′ of the person.

Further, in the above-described embodiments, the musical tone generation is controlled using a cellular phone with a built-in motion sensor 114. Alternatively, a cellular phone with no built-in motion sensor 114 may be used, and then the musical tone generation control may be carried out based on voice input to a microphone by the user.

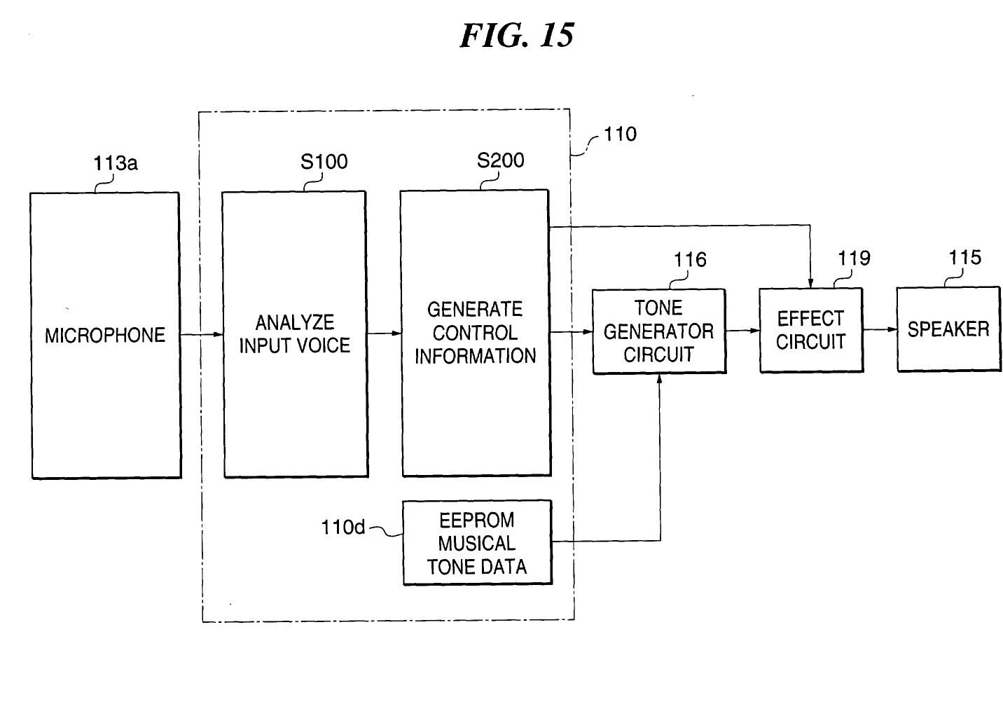

FIG. 15 shows a control process carried out by this alternative cellular phone 611 employing a microphone 113a instead of the motion sensor 114 of the cellular phone 11 of the first embodiment, in which the microphone 113a is a part of the user interface section 113 and can be used for telephone speech, in controlling musical tones to be sounded by a speaker 115 based on voice input to the microphone. As shown in FIG. 15, in the cellular phone 611, a voice uttered by the user is picked up by the microphone 113a of the user interface section 113, and a voice signal from the microphone 113a is output to a control section 110. The control section 110 first carries out a process of analyzing the voice signal received from the microphone 113a. In this analyzing process, the meaning of speech of the user may be analyzed by a known speech recognition technology. In the illustrated example, the pitch, formant (phonetic analysis), volume, enunciation timing, pause timing, etc. of the input voice are analyzed (step S100).

After completion of the analysis of the input voice, the control section 110 carries out a process of generating control information based on the result of this analysis. For example, the control section 110 generates control information instructing change of the pitch of a musical tone signal to be generated according to the pitch of the input voice, and control information controlling the volume (amplifying factor) according to the volume of the input voice. The control section 110 may also generate control information designating the pitch of a musical tone signal to be generated, based on a phoneme (for example, “a”, “i”, etc.) of voice determined by a formant analysis or the like.

Then, the control section 110, as in the first embodiment (FIG. 2), outputs the thus generated control information to a tone generator circuit 116 and an effect circuit 119. The tone generator circuit 116, as in the first embodiment, generates a musical tone signal based on the musical tone data stored in the EEPROM 110d and the control information, and outputs the generated musical tone signal to the effect circuit 119. The effect circuit 119 applies an effect or effects according to the control information supplied from the control section 110, to the musical tone signal supplied from the tone generator circuit 116 and outputs the resulting musical tone signal to the sound speaker 115. Thus, musical tones reflecting the voice the user has input to the microphone 113a are sounded by the sound speaker 115. For example, if the control section 110 is designed to generate such control information that causes, when the user sings the vocal part of a certain piece of music, the accompaniment of the piece of music to be sounded by the sound speaker 115 based on the result of analysis of the voice input by the sining user to the microphone 113a, it is possible to automatically sound the accompaniment of a certain piece of music through the sound speaker 115 in timing with the vocal part of the piece of music when the user sings the vocal part. Further, if the control section 110 is designed to generate control information instructing applying a reverberation to the singing tone, it is possible not only to automatically sound the accompaniment part as performed by a player but also to sound the singing voice of the user as a reverbed singing tone.

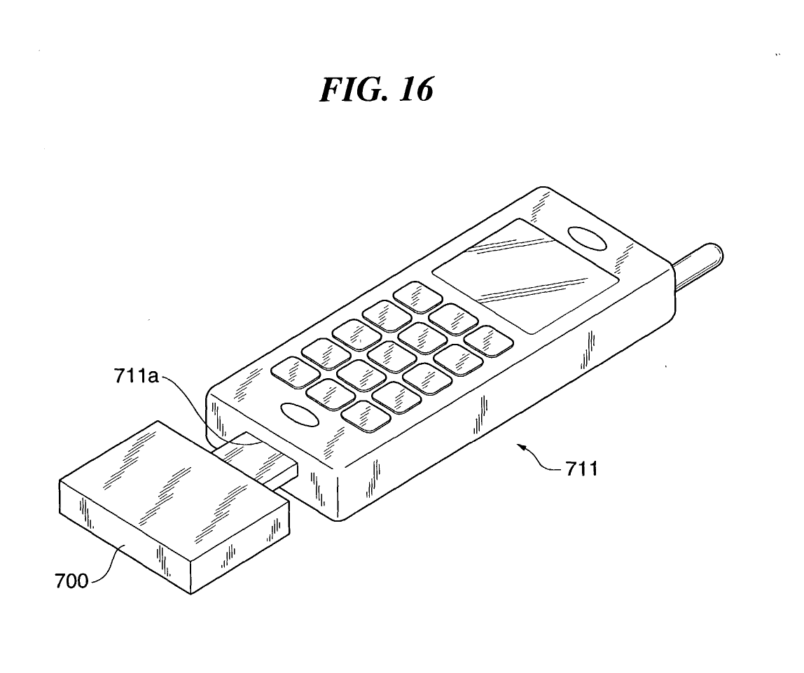

Further, although in the above-described embodiments, generation of musical tones is controlled using a cellular phone with a built-in motion sensor 114, an alternative cellular phone with no built-in motion sensor 114 and to which a sensor unit 700 as shown in FIG. 16 is attached instead of the motion sensor 114, may be used to control the musical tone generation.

As shown in FIG. 16, the sensor unit 700 is attached to the cellular phone 711 without the motion sensor 114, by fitting into an attaching port 711a thereof. The cellular phone 711 can be easily removed from the cellular phone 711 so that for use as an ordinary cellular phone, the sensor unit 700 is removed from the cellular phone 711, while for use in controlling the musical tone generation in the same manner as in the above-described embodiments, the cellular phone 711 is used with the sensor unit 700 attached thereto.

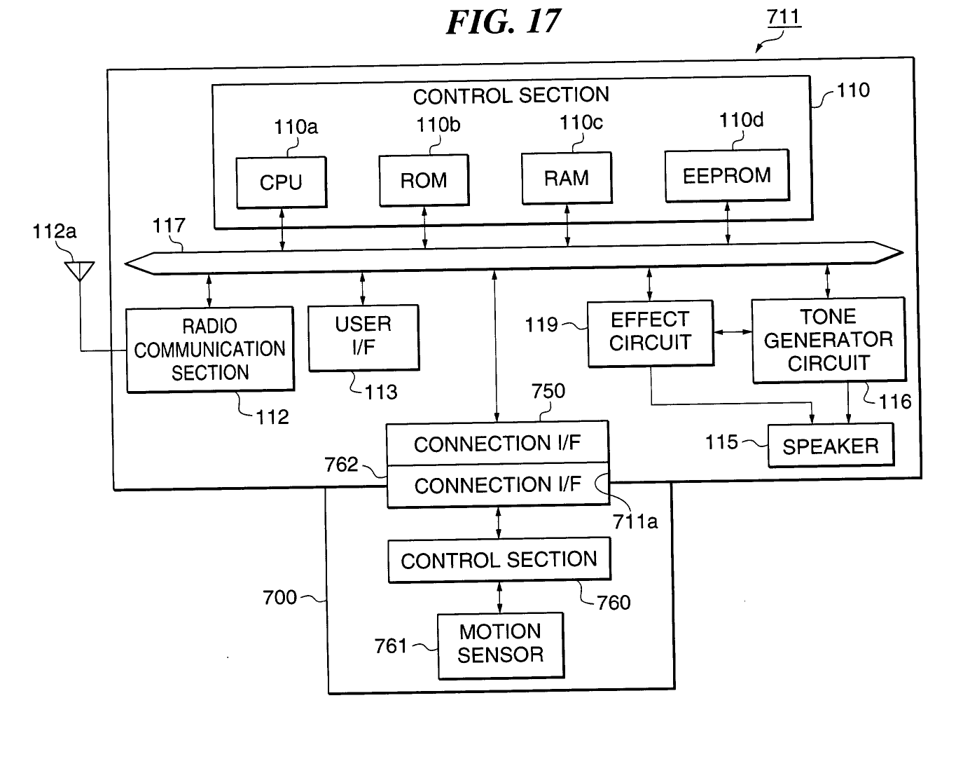

FIG. 17 shows the construction of the sensor unit 700 and the cellular phone 711. As shown in the figure, the cellular phone 711 is comprised of a control section 110, a radio communication section 112, a user interface section 113, a tone generator circuit 116, an effect circuit 119, and a bus 117 interconnecting these parts, and a sound speaker 115 connected to the tone generator circuit 116, which are all similar in function to the corresponding parts of the cellular phone 11 according to the first embodiment. The cellular phone 711 further includes a connection interface (I/F) 750 as a substitution for the motion sensor 114.

The connection interface 750 serves to transmit and receive data to and from external electronic equipment connected to the connecting port 711a, and when the sensor unit 700 is connected to the connecting port 711a of the cellular phone 711, the cellular phone 711 starts to transmit and receive data to and from the sensor unit 700.

The sensor unit 700 is comprised of a connection interface (I/F) 762, a control section 760, and a motion sensor 761. With the sensor unit 700 connected to the cellular phone 711, the connection interface 762 transmits and receive data to and from the connection interface 750, namely, the cellular phone 711.

The motion sensor 761, like the motion sensor 114 of the above-described embodiments, may be composed of one of various known forms such as a three-dimensional acceleration sensor, a three-dimensional velocity sensor, a two-dimensional acceleration sensor, a two-dimensional velocity sensor, a strain detector, or a tilt sensor, and detects a motion that the user has made by himself or herself on the cellular phone 711.

The control section 760 is comprised of a CPU, a ROM, a RAM, etc. As the CPU executes a control program stored in the ROM, the control section 760 controls a detection result transmission process of transmitting the result of detection by the motion sensor 761 to the cellular phone 711. Specifically, the control section 760 receives the result of detection by the motion sensor 761, converts the same into a format suitable to data communication with the cellular phone 711, and transmits the resulting detection result data to the cellular phone 711 via the connection interface 762.

Upon receipt of the detection result data transmitted from the sensor unit 700 via the connection interface 750, the cellular phone 711, as in the first embodiment, generates control information corresponding to the detection result data received by the control section 110, and controls the musical tone generation using the generated control information. Thus, the cellular phone 711 with the sensor unit 700 attached thereto can generate musical tones in a manner reflecting the motion of the user as in the first embodiment.

As described above, according to the present variation, as in the first embodiment, it is possible to use the cellular phone 711 not only as a means having the user actively participate in the musical tone generation, but also as an ordinary cellular phone, in which case the sensor unit 700 may be removed from the cellular phone 711 so that the sensor unit 700 is prevented from disturbing the telephone talking or other operations.

In the present variation, the cellular phone 711 with the sensor unit 700 connected thereto can control the musical tone generation in the same manner as the cellular phone 11 according to the first embodiment. In each of the above-described embodiments, instead of the cellular phone 211, the cellular phone 311 or the cellular phone 411, a sensor-less cellular phone without the motion sensor 114 may be provided with the same functions as those of the cellular phones of the above embodiments by having the sensor unit 700 connected to the sensor-less cellular phone.

Further, in the present variation, musical tones are generated using the tone generator circuit 116, the effect circuit 119 and the sound speaker 115, all carried by the cellular phone 711. Alternatively, the sensor unit 700 may carry the same parts as the tone generator circuit 110, the effect circuit 119 and the sound speaker 115, whereby the sensor unit 700 carries out musical tone generation. In this alternative form, the control section 760 of the sensor unit 700 generates control information according to the result of detection by the motion sensor 761, and the tone generator circuit 116, the effect circuit 119 and the sound speaker 115, which are carried by the sensor unit 700, cooperate to generate musical tones based on the generated control information and the musical tone data read from the EEPROM 110d of the cellular phone 711.

Further, although in the above-described embodiments, the musical tone generation control or other control is performed using a cellular phone, any type of mobile communication terminal that is cable of receiving communication services on a mobile communication network, such as PHS (Personal Handy-phone System (registered trademark)) may be aslo used instead of the cellular phone.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of the embodiment described above, and hence the storage medium on which the program code is stored constitutes the present invention.

Examples of the storage medium for supplying the program code include a floppy (registered trademark) disk, a hard disk, an optical disk, a magnetic-optical disk, a CD-ROM, a CD-R, a CD-RW, DVD-ROM, a DVD-RAM, a DVD-RW, a DVD+RW, a magnetic tape, a nonvolatile memory card, and a ROM.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into an expansion board inserted into a computer or a memory provided in an expansion unit connected to the computer and then causing a CPU or the like provided in the expansion board or the expansion unit to perform a part or all of the actual operations based on instructions of the program code.

What is claimed is:

1. A mobile communication terminal for receiving communication services via a mobile communication network, comprising:
a motion sensor that detects a motion of a user on said mobile communication terminal;
a storage device that stores musical tone information;
a control information generating device that generates musical tone control information in accordance with results of detection of said motion sensor; and
a musical tone generating device that generates musical tones based on the musical tone information stored in said storage device and the musical tone control information generated by said control information generating device.

2. A mobile communication terminal according to claim 1, further comprising:
a requesting device that requests a musical tone information providing apparatus connected to the mobile communication network to supply musical tone data to the mobile communication terminal via the mobile communication network; and
a receiving device that receives the musical tone data supplied from the musical tone information providing equipment via the mobile communication network; and
wherein said storage device stores the musical tone data received by said receiving device.

3. A mobile communication terminal for receiving communication services via a mobile communication network, comprising:
a motion sensor that detects a motion of a user on said mobile communication terminal; and
a detection result transmitting device that transmits detection result information corresponding to results of detection of said motion sensor to an external device connected to the mobile communication network, via the mobile communication network.

4. A mobile communication terminal for receiving communication services via a mobile communication network, comprising:
a microphone via which voice is input;
a storage device that stores musical tone information;
a control information generating device that generates musical tone control information based on the voice input via said microphone; and
a musical tone generating device that generates musical tones based on the musical tone information stored in said storage device and the musical control information generated by said control information generating device.

5. A sensor unit detachably mounted on a mobile communication terminal for receiving communication services via a mobile communication network, the mobile communication terminal including a storage device that stores musical tone information, and a musical tone generating device that generates musical tones in accordance with the musical tone information stored in said storage device and a motion of a user on the mobile communication terminal, the sensor unit comprising:
a motion sensor that detects the motion of the user on the mobile communication terminal with the sensor unit attached thereto and generates detection result information corresponding to results of detection of said motion sensor; and
an output device that outputs the detection result information generated by said motion sensor, to the mobile communication terminal with the sensor unit mounted thereon.

6. A sensor unit detachably mounted on a mobile communication terminal for receiving communication services via a mobile communication network, the mobile communication terminal including a storage device that stores musical tone information, the sensor unit comprising:
a motion sensor that detects a motion of a user on the mobile communication terminal with the sensor unit attached thereto;
a control information generating device that generates musical tone control information based on results of detection of said motion sensor; and
a musical tone generating device that reads the musical tone information stored in the storage device of the mobile communication terminal with said motion sensor attached thereto, and generates musical tones based on the musical tone information read from the storage device and the musical tone control information generated by said control information generating device.

7. A musical tone generating system comprising:
a mobile communication terminal for receiving communication services via a mobile communication network; and
a musical tone information generating device connected to said mobile communication network;
said mobile communication terminal including:
at least one motion sensor built in said mobile communication terminal or attached to said mobile communication terminal, for detecting a motion of a user on said mobile communication terminal; and
a detection result transmitting device that transmits detection result information corresponding to results of detection of said motion sensor to said musical tone information generating device via the mobile communication network;
said musical tone information generating device including:
a receiving device that receives the detection result information transmitted from said mobile communication terminal; and
a musical tone information generating section that generates musical tone information based on the detection result information received by said receiving device.

8. A musical tone generating system according to claim 7, wherein said musical tone information generating device further includes a musical tone information transmitting device that transmits the musical tone information generated by said musical tone information generating section, to said mobile communication terminal via the mobile communication network; and
wherein said mobile communication terminal further includes a musical tone generating device that generates musical tones based on the musical tone information transmitted from said musical tone information transmitting device of said musical tone information generating device based on the detection result information transmitted from said detection-result transmitting device.

9. A musical tone generating system according to claim 7, wherein said musical tone information generating device further includes a musical tone generating device that generates musical tones based on the musical tone information generated by said musical tone information generating section.

10. A musical tone generating system according to claim 7, wherein said musical tone information generating device further includes:
a musical tone information obtaining device obtaining second musical tone information from an external device; and
an instruction transmitting device that, when generating the musical tone information based on the obtained second musical tone information obtained by said musical tone information obtaining device, transmits instruction information based on the obtained musical tone information to said mobile communication terminal via the mobile communication network;
wherein said musical tone information generating section generates the musical tone information based on both the obtained second musical tone information and the detection result information; and
wherein said mobile communication terminal further includes:
an instruction receiving device that receives the instruction information transmitted from said instruction transmitting device, and
a notifying device that notifies the user of contents of an instruction corresponding to the instruction information received by said instruction receiving device.

11. A musical tone generating apparatus comprising:
a receiving device that receives detection result information corresponding to results of detection of at least one motion sensor from a mobile communication terminal receiving communication services via a mobile communication network, the motion sensor detecting a motion of a user on the mobile communication network; and
a musical tone information generating device that generates musical tone information based on the detection result information received by said receiving device.

12. A musical tone generating apparatus according to claim 11, further comprising a music information storage device that stores music information, and wherein said musical tone information generating device generates the musical tone information based on the music information stored in said music information storage device and the detection result information received by said receiving device.

13. A musical tone generating apparatus according to claim 12, wherein said receiving device receives the detection result information addressed to a plurality of predetermined access numbers; and
wherein the music information comprises a plurality of parts allocated to respective ones of the access numbers and the musical tone information is to be generated for each of the parts, and said musical tone information generating device generates the musical tone information based on the music information for each of the parts and the detection result information addressed to a corresponding one of the access numbers.

14. A musical tone generating apparatus according to claim 11, further comprising a musical tone information transmitting device that transmits the musical tone information generated by said musical tone information generating device, to the mobile communication terminal as a source of transmission of the detection result information, via the mobile communication network.

15. A method of providing musical tone information to a mobile communication terminal for receiving communication services via a mobile communication network, the mobile communication terminal having a motion sensor that detects a motion of a user on the mobile communication terminal, the method comprising the steps of:
causing a musical tone information providing apparatus connected to the mobile communication terminal to receive detection result information corresponding to results of detection of the motion sensor transmitted from the mobile communication terminal via the mobile communication network;
generating musical tone information based on the received detection result information; and
causing the musical tone information providing apparatus to transmit the generated musical tone information to the mobile communication terminal as a source of transmission of the detection result information, via the mobile communication network.

16. A program for implementing a method of providing musical tone information to a mobile communication terminal for receiving communication services via a mobile communication network, the mobile communication terminal having a motion sensor that detects a motion of a user on the mobile communication terminal, the method comprising the steps of:
causing a musical tone information providing apparatus connected to the mobile communication terminal to receive detection result information corresponding to results of detection of the motion sensor transmitted from the mobile communication terminal via the mobile communication network;
generating musical tone information based on the received detection result information; and causing the musical tone information providing apparatus to transmit the generated musical tone information to the mobile communication terminal as a source of transmission of the detection result information, via the mobile communication network.
